(19) United States
(12) Patent Application Publication
(10) Pub. No.: US 2026/0217901 A1
(43) Pub. Date: Jul. 30, 2026

(54) UREA (METH)ACRYLATE OR UREA-URETHANE (METH)ACRYLATE OLIGOMER, COMPOSITIONS COMPRISING SAME AND USES THEREOF

(71) Applicant: Arkema France, Colombes (FR)

(72) Inventors: Sylvain BEAUDRAIS, Verneuil En Halatte (FR); Christophe DUQUENNE, Verneuil En Halatte (FR)

(21) Appl. No.: 18/723,987

(22) PCT Filed: Dec. 15, 2022
(86) PCT No.: PCT/EP2022/086204

§ 371 Date: Jun. 25, 2024

(30) Foreign Application Priority Data
Dec. 31, 2021 (FR) FR2114723

(51) Int. Cl. C08G 18/67; B33Y 70/00; C08F 290/14

(52) U.S. Cl. CPC C08G 18/673; B33Y 70/00; C08F 290/147

(57) ABSTRACT

The present invention relates to a urea (meth)acrylate or urea-urethane (meth)acrylate oligomer comprising:
at least two urea bonds, in particular at least two hindered urea bonds,
at least two (meth)acryloyloxy groups, in particular at least two acryloyloxy groups, and
optionally at least one urethane bond, in particular optionally at least two urethane bonds.

The present invention is also directed toward a polymerizable composition comprising at least one oligomer according to the present invention and optionally at least one other ethylenically unsaturated compound.

A process for manufacturing a crosslinked product, comprising a step of crosslinking a polymerizable composition according to the invention, also forms part of the invention.

A process for manufacturing a three-dimensional object, comprising an additive manufacturing step using a polymerizable composition according to the invention, also forms part of the invention.

The invention is also directed toward a crosslinked product obtained by crosslinking a polymerizable composition according to the invention or obtained via a process according to the invention.

Finally, the invention relates to the use of an oligomer according to the invention as a binder in a polymerizable composition or in a composition for additive manufacturing, and to the use of a polymerizable composition according to the invention for the production of an ink, a coating, a material filled with fibrous or particulate reinforcements which may be carbon nanotubes or graphite, an adhesive, a molded material, an ink plate, an electrode binder, or an object obtained by additive manufacturing.

### TECHNICAL FIELD

The present invention relates to a urea (meth)acrylate or urea-urethane (meth)acrylate oligomer, to polymerizable compositions comprising same, and to uses thereof, in particular as a binder in a polymerizable composition, notably in an ink or coating composition, material filled with fibrous or particulate reinforcements which may be carbon nanotubes or graphite, an adhesive, molding, ink plate or electrode binder composition, and in a composition for additive manufacturing, notably for the 3D or 4D printing of objects.

### PRIOR ART

It is known practice to prepare high-functionality urethane acrylates by reacting an amine with an acrylate, and then adding the aminoacrylate obtained to an isocyanate.

WO 2007/005351 describes liquid compositions of self-photoinitiating multifunctional urethane acrylate oligomers bearing pendant acrylate groups and tertiary amine groups incorporated into the polymer backbone, obtained by reacting two oligomeric molecules comprising primary hydroxyl groups with the terminal isocyanate groups of a tertiary N-bis-urethane aminoacrylate oligomer.

WO 2016/170264 describes a urethane aminoacrylate-acrylate comprising a urethane function linked to an aminoacrylate group, the latter bearing one or more acrylate groups and being derived from a) a hydroxylated aminoacrylate bearing one or more acrylate groups with b) a polyisocyanate, the aminoacrylate a) being the product of addition of a1) an amino alcohol bearing a hydroxyl group and a secondary amine group onto a2) a multifunctional acrylate, with a2) being in stoichiometric excess relative to the secondary amine groups of the amino alcohol a1).

The urethane acrylates of the prior art are obtained from secondary amines, which involves the formation of a significant amount of tertiary amine prior to isocyanate addition, the tertiary amine functions being moreover useful for catalyzing the desired urethanization reaction. It turns out, however, that tertiary amines are sensitive to certain types of chemical attack (acids) and become colored (yellowing) during UV crosslinking. In addition, the preparation of these urethane acrylates requires prolonged high-temperature heating and the use of toxic metal catalysts, such as tin catalysts.

Thus, the present invention seeks to overcome the drawbacks of the urethane acrylates of the prior art by eliminating the presence of tertiary amines prior to isocyanate addition. To this end, the inventors have modified the urethane acrylate nature of the final oligomer to urea (meth)acrylate or urea-urethane (meth)acrylate.

The solution proposed by the inventors is based on the reaction between an isocyanate and a secondary amine to form a urea, without requiring the presence of any catalyst. More particularly, the proposed solution consists in using a compound simultaneously comprising at least one secondary amine function and at least one (meth)acrylate function. In principle, this synthesis is difficult to control due to the coexistence of secondary amine and (meth)acrylate functions which may react together. However, an original feature imposed on the amine makes it possible to obtain a stable compound containing both secondary amine and (meth)acrylate functions, without the formation of tertiary amines: the secondary amine is sterically hindered, i.e. substituted α or β to the amine function, said steric hindrance of the amine allowing the reaction kinetics between the isocyanate (NCO) and secondary amine (NH) functions to be controlled.

Thus, the urea (meth)acrylate or urea-urethane (meth)acrylate oligomer of the invention affords the following technical advantages relative to the urethane acrylates of the prior art:
the absence or very low content of tertiary amine leads to very good color stability of the oligomer after crosslinking (no coloring, no yellowing),
the overall properties of the oligomer are equivalent to or better than those of urethane acrylates, but without the presence of by-products linked to stabilizer consumption and the more severe thermal synthetic conditions (higher purity of the oligomer of the invention),
improved abrasion resistance,
better viscosity/hardness compromise than urethane acrylates, the urea function being harder and more viscous than the urethane function of urethane acrylates,
simpler, faster, safer and more economical synthesis, due to the absence of prolonged heating (the reactor being able to be maintained simply at the desired temperature by virtue of the exothermicity of the reaction and the temperature controlled by the rate of addition of the starting materials), whereas the synthesis of certain urethane acrylates requires temperature increases of up to 130° C., and
a more environmentally-friendly process, free of toxic compounds since it does not require the use of solvents or catalysts, in particular of metal catalysts such as tin-based catalysts.

The first subject of the present invention thus relates to a specific urea (meth)acrylate or urea-urethane (meth)acrylate oligomer.

Another subject relates to a polymerizable composition comprising at least one oligomer according to the present invention and optionally at least one other ethylenically unsaturated compound.

A process for manufacturing a crosslinked product comprising a step of crosslinking a polymerizable composition according to the invention is also concerned.

A process for manufacturing a three-dimensional object comprising an additive manufacturing step using a polymerizable composition according to the invention is also concerned.

Next, the invention relates to a crosslinked product obtained by crosslinking a polymerizable composition according to the invention or obtained via a process according to the invention.

Another subject relates to the use of an oligomer according to the invention as a binder in a polymerizable composition or in a composition for additive manufacturing, in particular for the 3D or 4D printing of an object.

Finally, the present invention relates to the use of a polymerizable composition according to the invention for the production of an ink, a coating, a material filled with fibrous or particulate reinforcements which may be carbon nanotubes or graphite, an adhesive, molding, ink plate or electrode binder composition, or a composition for additive manufacturing, in particular for the 3D or 4D printing of objects.

Thus, the first subject of the present invention relates to a specific urea (meth)acrylate or urea-urethane (meth)acrylate oligomer comprising:
at least two urea bonds, in particular at least two hindered urea bonds,
at least two (meth)acryloyloxy groups, in particular at least two acryloyloxy groups, and
optionally at least one urethane bond, in particular optionally at least two urethane bonds.

For the purposes of the invention, the term “oligomer” corresponds to a polymer molecule consisting of identical and/or different monomer units, preferably from 2 to 50 and more preferably from 2 to 20 identical and/or different monomer units. An oligomer may notably be obtained by reaction between at least one monomer A containing at least two functions f_{A} and at least one monomer B containing at least two functions f_{B}, the functions f_{A} being capable of reacting with the functions f_{B}. Examples of oligomers are products obtained by polycondensation (notably between at least one polyacid and at least one polyol and/or at least one polyamine) or by polyaddition (notably between at least one polyisocyanate and at least one polyol and/or at least one polyamine).

For the purposes of the invention, a “hindered urea bond” is a urea bond containing at least one substituent or ring in the α or β position relative to the nitrogen atom to which it is bonded.

For the purposes of the invention, a (meth)acryloyloxy group corresponds to a (meth)acrylate function.

Preferably, the two (meth)acryloyloxy groups of the oligomer of the invention are terminal (meth)acryloyloxy groups of said oligomer. For the purposes of the invention, a terminal group is a group at the end of the main chain of the oligomer.

The oligomer of the invention may comprise at least two hindered urea bonds linked together by a linker group, each hindered urea bond being connected to said linker group by a nitrogen atom not bearing any hydrogen atoms. Said hindered urea bonds linked together by a linker group may be identical or different, and are preferably identical.

For the purposes of the invention, hindered urea bonds are preferably bonds of formula *—NR—C(═O)—NH—*, in which: R is other than H, preferably R is a hindered group, and the * symbols each represent a point of attachment to a carbon atom.

In this embodiment, preferably, the linker group does not comprise any urea bonds or urethane bonds.

The oligomer of the invention may in particular comprise at least one fragment corresponding to formula (I) below:

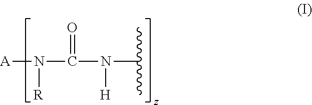

in which:
the linker group A is the residue of a polyamine, and preferably A does not comprise any urea bonds or urethane bonds,
R is other than H, and preferably R is a hindered group,
z is an integer from 2 to 6, and

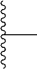

represents a point of attachment to a carbon atom.

For the purposes of the invention, when R is a hindered group, it is preferably a group containing at least one substituent or ring in the α or β position relative to the nitrogen atom to which it is bonded. A substituent may notably be any group other than H or a ring, for example a group chosen from optionally alkoxylated alkyl. A ring may notably be chosen from cycloalkyl, heterocycloalkyl, aryl or heteroaryl.

The oligomer of the invention may comprise at least two urea bonds, each urea bond being directly linked to a group originating from an aza-Michael reaction between a primary amine and an α,β-unsaturated carbonyl compound, and in particular an aza-Michael reaction between:
a) a hindered primary amine and a (meth)acrylate, or
b) a primary amine and a maleate or fumarate diester.

For the purposes of the invention, a “primary amine” is a compound containing at least one primary amine function —NH₂, and preferably not containing any secondary and/or tertiary amine functions.

For the purposes of the invention, a “hindered primary amine” is a primary amine containing at least one substituent or ring in the α or β position relative to the nitrogen atom of the primary amine function to which it is bonded.

For the purposes of the invention, an “α,β-unsaturated carbonyl compound” is a compound containing a C═C double bond in the α-β-unsaturated position relative to a carbonyl group, in particular carboxylic acid, ester, anhydride, ketone or aldehyde.

For the purposes of the invention, a “maleate or fumarate diester” is a diester derived from maleic acid or fumaric acid.

The oligomer of the invention may comprise at least two fragments corresponding to formula (Ia) below:

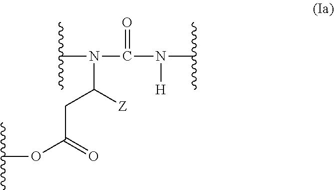

in which:
Z is H or a group comprising an ester function —COOY,
Y is an alkyl group, optionally substituted with one or more (meth)acrylate groups, and preferably Y is a linear or branched C₁-C₁₃ alkyl group, optionally substituted with one or more (meth)acrylate groups, and

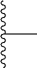

represent points of attachment to a carbon atom.

In this embodiment, the oligomer of the invention may comprise:
at least four fragments of formula (Ia), or
at least two fragments (Ia) and two urethane bonds, or
at least two fragments (Ia) and at least two other hindered urea bonds.

For the purposes of the present invention, the following definitions apply:
Alkyl: a linear or branched, saturated C₁-C₂₀, preferably C₁-C₁₃, more preferentially C₁-C₆ and even more preferentially C₁-C₄ aliphatic hydrocarbon-based group. A C₁-C₂₀ alkyl means an alkyl containing from 1 to 20 carbon atoms. The term “branched” means that at least one alkyl group such as methyl or ethyl is borne by a linear alkyl chain. Examples of alkyl groups that may be mentioned include methyl, ethyl, n-propyl, i-propyl, n-butyl, t-butyl and n-pentyl groups.
Alkyl containing at least one heteroatom: an alkyl in which at least one carbon atom is replaced with a heteroatom, notably chosen from O, N or S, preferably O.
Cycloalkyl: a non-aromatic, saturated or partially unsaturated, cyclic, preferably C₃-C₁₀ hydrocarbon-based group, which may be monocyclic, bicyclic or polycyclic.
Heterocycloalkyl; a cycloalkyl in which at least one ring atom is a heteroatom, preferably chosen from O, N or S.
Aryl: a group containing at least one aromatic ring. An aryl may contain a single aromatic ring or several rings, at least one of which is aromatic. An aromatic ring corresponds to a ring that complies with HOckel's rule. Examples of aryl groups are phenyl, biphenyl, naphthyl and anthracenyl. The aryl groups of the invention preferably comprise from 6 to 12 carbon atoms. Even more preferably, the aryl group of the invention is a phenyl group.
Heteroaryl: an aryl in which at least one ring atom of the aromatic ring is a heteroatom, preferably chosen from O, N or S.
Alkylene: an aliphatic radical derived from an alkane of formula CₘH₂ₘ₊₂ with m=2 to 50, by removing a hydrogen atom at each point of attachment of the radical. An alkylene may be linear or branched. An alkylene may be divalent, trivalent, tetravalent, pentavalent or hexavalent.
Oxyalkylene: an alkylene interrupted with at least one oxygen atom, and preferably corresponding to the formula -Alk′-[O-Alk′]ₖ- in which each Alk′ is independently an alkylene and k″ ranges from 1 to 50.

More particularly, the oligomer of the invention may comprise at least two fragments corresponding to one of the formulae (Ib) or (Ic) below:

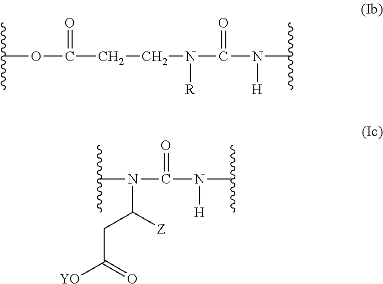

in which
R is other than H, and preferably R is a hindered group,
Z is H or a group comprising an ester function —COOY,
Y is an alkyl group, optionally substituted with one or more (meth)acrylate groups, and preferably Y is a linear or branched C₁-C₁₃ alkyl group, optionally substituted with one or more (meth)acrylate groups, and

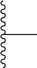

represent points of attachment to a carbon atom.

In this embodiment, the oligomer of the invention may comprise:
at least four fragments of formula (Ib), or
at least two fragments (Ib) and two urethane bonds, or
at least two fragments (Ib) and at least two other hindered urea bonds.

In this embodiment, the oligomer of the invention may comprise:
at least two fragments (Ic) and at least two urethane bonds, or
at least two fragments (Ic) and at least two other hindered urea bonds.

The oligomer of the invention may comprise a fragment corresponding to one of the formulae (Id) or (Ie) below:

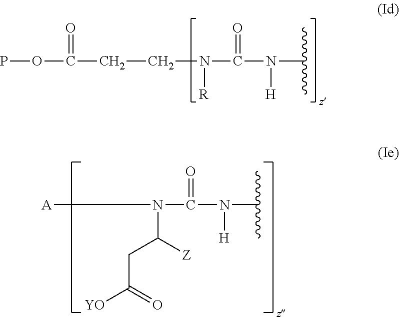

in which:
R is other than H, and preferably R is a hindered group,
Z is H or a group comprising an ester function —COOY;
Y is an alkyl group, optionally substituted with one or more (meth)acrylate groups, and preferably Y is a linear or branched C₁-C₁₃ alkyl group, optionally substituted with one or more (meth)acrylate groups,
P is the residue of a polyol, preferably not comprising any urea bonds or urethane bonds, and more preferentially P is an alkylene, which is optionally alkoxylated or esterified, for example with at least one ester function derived from the opening of a lactone such as caprolactone,
A is the residue of a polyamine, and preferably A does not comprise any urea bonds or urethane bonds,
z′ is an integer from 2 to 6,
z″ is an integer from 2 to 6, and

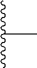

represents a point of attachment to a carbon atom.

According to one embodiment, the oligomer of the invention may be the product of reaction between at least one poly(meth)acrylate, at least one hindered primary monoamine and at least one isocyanate compound, the oligomer preferably being obtained via a process comprising the following successive steps:
(i) aza-Michael reaction between at least one poly(meth)acrylate and at least one hindered primary monoamine with a stoichiometric excess of (meth)acryloyloxy groups relative to the primary amine groups, preferably with an NH₂/(meth)acryloyloxy ratio of less than 0.9, preferably ranging from 0.1 to 0.8, or from 0.2 to 0.7, or from 0.3 to 0.5, and
(ii) reaction of the amino-(meth)acrylate mixture obtained in step (i) with at least one isocyanate compound, preferably with an NCO/NH₂ ratio of less than 1.05, preferably ranging from 0.6 to 1.01, or from 0.8 to 1, or from 0.9 to 0.99.

For the purposes of the invention, a “poly(meth)acrylate” is a compound containing at least two (meth)acryloyloxy groups and at least one of the (meth)acryloyloxy groups is an acryloyloxy group.

In this embodiment, the poly(meth)acrylate of step (i) is preferably a compound containing at least 2, preferably 2 to 6 and more preferably 2 to 4 (meth)acryloyloxy groups and in which at least one of the (meth)acryloyloxy groups is an acryloyloxy group.

For the purposes of the invention, a “primary monoamine” is a compound containing a single primary amine function —NH₂, and preferably not containing any secondary and/or tertiary amine functions.

For the purposes of the invention, a “hindered primary monoamine” is a primary monoamine having at least one substituent or ring in the α or β position relative to the nitrogen atom of the primary amine function to which it is attached.

More particularly, in this embodiment, the hindered primary monoamine of step (i) may correspond to formula (II) below:

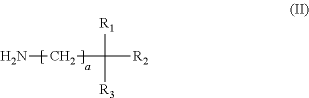

in which:
R₁ and R₂ are, independently of each other, chosen from alkyl, cycloalkyl, heterocycloalkyl, aryl, heteroaryl or alkyl groups containing at least one heteroatom, or R₁ and R₂ may form a C₄-C₈, preferably C₆, ring optionally comprising one or more heteroatoms,
R3 is H or an alkyl group, preferably C₁-C₄, and more preferentially —CH₃,
a is equal to 0 or 1.

Even more particularly, in this embodiment, the hindered primary monoamine of step (i) corresponds to one of the formulae (IIa), (IIb) or (IIc) below:

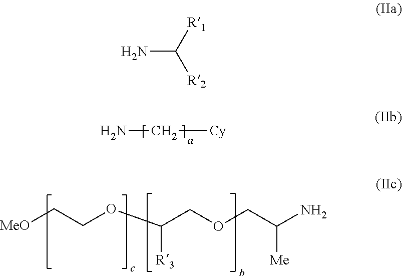

in which:
R′₁ and R′₂ are, independently of each other, preferably C₁-C₄ and more preferentially C₁-C₂ alkyl groups,
Cy is a C₄-C₈ and preferably C₆ ring,
R′₃ is H or a methyl group,
a is equal to 0 or 1,
b and c are, independently of each other, integers ranging from 1 to 50.

Even more particularly, in this embodiment, the hindered primary monoamine of step (i) is chosen from: 2-aminopentane, 3-aminopentane, 1,2-dimethylpropylamine, 1,3-dimethylbutylamine, 2-aminooctane, isopropylamine, isobutylamine, sec-butylamine, tert-butylamine, tert-octylamine (2-amino-2,4,4-trimethylpentane), 2-ethylhexylamine, (2-methylbutyl)amine, cyclopentylamine, cyclohexylamine, 3,3,5-trimethylcyclohexylamine, cycloheptylamine, benzylamine, a polyether monoamine based on polypropylene glycol and optionally ethylene glycol preferably having a weight-average molecular weight M_{w} ranging from 200 to 3000 g·mol⁻¹ (Jeffamine® M-600, Jeffamine® M-1000 or Jeffamine® M-2005), and mixtures thereof.

In this embodiment, the isocyanate compound of step (ii) is preferably a compound containing at least one —NCO group.

More particularly, in this embodiment, the isocyanate compound of step (ii) may comprise:
a polyisocyanate, and optionally a (meth)acrylate functionalized with an OH or NHR′ group, or
an adduct obtained by reaction between a polyisocyanate and a (meth)acrylate functionalized with an OH or NHR′ group with a stoichiometric excess of NCO groups relative to the OH or NHR′ groups, said adduct being formed prior to reaction with the compound obtained on conclusion of step (i),
R′ being a group other than H, and in particular a hindered group.

For the purposes of the invention, and as for R, when R′ is a hindered group, it is preferably a group containing at least one substituent or ring in the α or β position relative to the nitrogen atom to which it is attached. Preferably, R′ is a tert-butyl group.

Thus, in this embodiment, the polyisocyanate of step (ii) may:
either be alone, and react with a mono(meth)acrylate having a secondary amine function present in the mixture of amino-(meth)acrylates obtained in step (i), and lead to the formation of hindered urea bonds by aza-Michael reaction on the secondary amine during step (ii),
or be in admixture or in the form of an adduct with a (meth)acrylate functionalized with an OH group during step (i), and lead to the formation of urethane bonds during step (ii),
or be in admixture or in the form of an adduct with a (meth)acrylate functionalized with a group NHR′ during step (i), and lead to the formation of hindered urea bonds with a group R′ during step (ii).

Even more particularly, in this embodiment:
the polyisocyanate of step (ii) is a diisocyanate, and
the OH-functionalized (meth)acrylate of step (ii) is 2-hydroxyethyl acrylate or 2-hydroxyethyl methacrylate, or the NHR′-functionalized (meth)acrylate of step (ii) is 2-(tert-butylamino)ethyl methacrylate.

According to another embodiment, the oligomer of the invention may be the product of reaction between at least one mono(meth)acrylate, at least one hindered primary polyamine and at least one isocyanate compound, the oligomer preferably being obtained via a process comprising the following successive steps:
(i′) aza-Michael reaction between at least one mono(meth)acrylate and at least one hindered primary polyamine to form a poly(amino ester), in particular with an NH₂/double bond ratio ranging from 0.7 to 1.3, preferably from 0.9 to 1.1, or from 0.95 to 1.05,
(ii′) optionally addition of an acrylate to eliminate the residual primary amine functions,
(iii′) reaction of the poly(amino ester) obtained in step (i′) or (ii′) with at least one isocyanate compound, and
in which the isocyanate compound comprises:
   a polyisocyanate and a (meth)acrylate functionalized with an OH or NHR′ group, or
   an adduct obtained by reaction between a polyisocyanate and a (meth)acrylate functionalized with an OH or NHR′ group with a stoichiometric excess of NCO groups relative to the OH or NHR′ groups, said adduct being formed prior to reaction with the compound obtained on conclusion of step (i′) or (ii′), and R′ being a group other than H, in particular a hindered group, and being as defined previously.

For the purposes of the invention, a “mono(meth)acrylate” is a compound containing a single acryloyloxy group, and optionally one or more methacryloyloxy groups.

For the purposes of the invention, a “primary polyamine” is a compound containing at least two primary amine functions —NH₂, and preferably not containing any secondary and/or tertiary amine functions.

For the purposes of the invention, a “hindered primary polyamine” is a primary polyamine in which each primary amine function is hindered by a substituent or ring in the α or β position relative to the nitrogen atom of the primary amine function to which it is attached.

More particularly, the hindered primary polyamine of step (i′) corresponds to one of the formulae (IIIa), (IIIb), (IIIc), (IIId) and (IIIe) below:

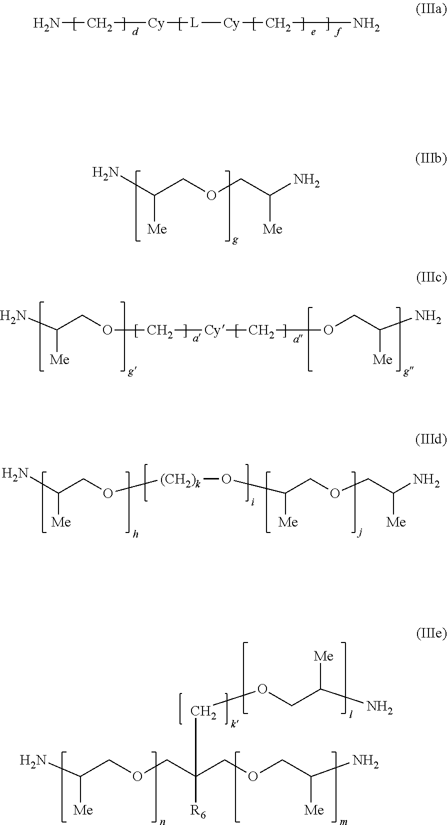

in which:
Cy is a C₄-C₈ and preferably C₆ ring, or Cy is —CR₄R₅—,
Cy′ is a C₄-C₈ and preferably C₆ ring,
R₄ is an alkyl group,
R₅ is H or an alkyl group,
R₆ is H or an alkyl or alkoxy group,
L is a single bond, an alkylene or an oxyalkylene,
a′, a″, d, e and f are, independently of each other, equal to 0 or 1,
g, g′, g″, h, i, j, l, m and n are, independently of each other, integers ranging from 1 to 50,
k is equal to 2 or 4,
k′ is equal to 0 or 1.

Even more particularly, in this embodiment, the hindered primary polyamine of step (i′) is chosen from: 5-amino-1,3,3-trimethylcyclohexanemethylamine (isophorone diamine), 4,4′-methylenebis(cyclohexylamine), 4,4′-methylenebis(2-methylcyclohexylamine), 1,2-, 1,3- or 1,4-diaminocyclohexane, 1,2-, 1,3- or 1,4-cyclohexanebis(methylamine), 1,8-diamino-p-menthane, o-, m- or p-xylylenediamine, a non-cyclic polyether diamine based on polypropylene glycol and optionally polyethylene glycol or polytetramethylene glycol preferably having a weight-average molecular weight M ranging from 200 to 10 000 g·mol⁻¹ (Jeffamine® D-230, Jeffamine® D-400, Jeffamine® D-2000, Jeffamine® D-2010, Jeffamine® D-4000, Jeffamine® ED-600, Jeffamine® ED-900, Jeffamine® ED-2003, Jeffamine® THF170), a polyether triamine based on polypropylene glycol and optionally polyethylene glycol, preferably having a weight-average molecular weight M, ranging from 300 to 10 000 g·mol⁻¹ (Jeffamine® T-403, Jeffamine® T-3000, Jeffamine® T-5000), a cycloaliphatic polyether diamine preferably having a weight-average molecular weight M_{w} ranging from 500 to 5000 g·mol⁻¹ (Jeffamine® RFD-270), and mixtures thereof.

During step (i′), the NH₂/double bond ratio is preferably close to 1. In certain cases, it may be less than 1, so as to have residual acrylate in the mixture, which acts as a reactive diluent.

More particularly, in this embodiment:
the polyisocyanate of step (iii′) is a diisocyanate, and
the OH-functionalized (meth)acrylate of step (iii′) is 2-hydroxyethyl acrylate or 2-hydroxyethyl methacrylate, or the NHR′-functionalized (meth)acrylate of step (iii′) is 2-(tert-butylamino)ethyl methacrylate.

According to yet another embodiment, the oligomer of the invention may be the product of reaction between at least one maleate or fumarate diester, at least one primary polyamine and at least one isocyanate compound, the oligomer preferably being obtained via a process comprising the following successive steps:
(i″) aza-Michael reaction between at least one maleate or fumarate diester and at least one primary polyamine to form a poly(amino ester), in particular with an NH₂/double bond ratio ranging from 0.7 to 1.3, preferably from 0.9 to 1.1 or from 0.95 to 1.05,
(ii″) reaction of the poly(amino ester) obtained in step (i″) with at least one isocyanate compound, and
in which the isocyanate compound comprises:
   a polyisocyanate and a (meth)acrylate functionalized with an OH or NHR′ group, or
   an adduct obtained by reaction between a polyisocyanate and a (meth)acrylate functionalized with an OH or NHR′ group with a stoichiometric excess of NCO groups relative to the OH or NHR′ groups, said adduct preferably being formed prior to reaction with the compound obtained on conclusion of step (i″), and R′ being a group other than H, in particular a hindered group, and being as defined previously.

In this embodiment, the primary polyamine is preferably a diamine.

More particularly, in this embodiment:
the polyisocyanate of step (ii″) is a diisocyanate, and
the OH-functionalized (meth)acrylate of step (ii″) is 2-hydroxyethyl acrylate or 2-hydroxyethyl methacrylate, or the NHR′-functionalized (meth)acrylate of step (ii″) is 2-(tert-butylamino)ethyl methacrylate.

Advantageously, the oligomer of the invention comprises at least one product corresponding to formula (IV) below:

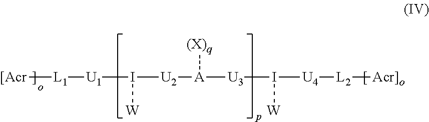

in which:
each Acr is, independently of each other, a (meth)acryloyloxy group,
L₁ and L₂ are, independently of each other, [●]ₒ—P—[O—C(═O)—CH₂—CH₂]ᵣ—♦,
P is the residue of a polyol, and preferably P is an optionally alkoxylated or esterified alkylene,
the symbol ● represents a point of attachment to an Acr group,
the symbol ♦ represents the point of attachment to the group U₁ or U₄,
U₁ and U₄ are, independently of each other, chosen from a urea bond or a urethane bond,
U₂ and U₃ are a urea bond,
I is the residue of a polyisocyanate,
W is absent or represents a branch on the oligomer such as
U₁-L₂-[Acr]ₒ,
A is the residue of a polyamine,
X is absent or represents a branch on the oligomer such as
U₂-I-U₁-L₂-[Acr]ₒ,
each o is, independently of each other, an integer ranging from 1 to 5,
p is an integer ranging from 0 to 50, on condition that when p is equal to 0, at least one of the groups U₁ or U₄ is a urea bond,
each q is, independently of each other, an integer from 0 to 4, and
r is equal to 0 or 1.

When the functionality of the isocyanate compound used to prepare the oligomer of the invention is less than or equal to 2, W is absent. When the functionality of the isocyanate compound used to prepare the oligomer of the invention is greater than 2, W represents a branch on the oligomer, and preferably W is —U₁-L₂-[Acr]ₒ.

When the functionality of the amine or (meth)acrylate used to prepare the oligomer of the invention is less than or equal to 2, X is absent. When the functionality of the amine or (meth)acrylate used to prepare the oligomer of the invention is greater than 2, X represents a branch on the oligomer, and preferably X is —U₂-I-U-L₂-[Acr]ₒ.

More particularly, in formula (IV) of the oligomer of the invention, the (meth)acryloyloxy Acr groups are, independently of each other, represented by formula (V) below:

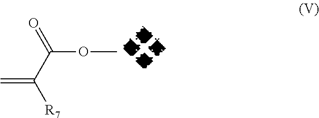

in which:
R₇ is H or a methyl group, and in particular R₇ is H,
the symbol [symbol] represents the point of attachment to the group L₁ or L₂.

More particularly, in formula (IV) of the oligomer of the invention, each I is the residue of an aliphatic, cycloaliphatic or aromatic polyisocyanate, and even more particularly an aliphatic or cycloaliphatic diisocyanate, said cycloaliphatic diisocyanate preferably being C₆-C₁₈.

In a particular embodiment, in formula (IV) of the oligomer of the invention, U₁ and U₄ are, independently of each other, a urea bond represented by formula (VI) below:

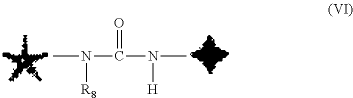

in which:
R₈ is a hindered group,
the symbol ★ represents the point of attachment to group L₁ or L₂,
the symbol [symbol] represents the point of attachment to group I, and
when p>0, U₂ and U₃ are, independently of each other, a urea bond represented by formula (VII) below:

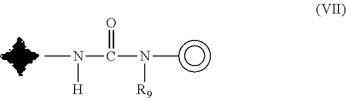

in which:
R₉ is a hindered group,
the symbol ★ represents the point of attachment to the group A, and
the symbol [symbol] represents the point of attachment to the group I.

For the purposes of the invention, R₈ is a hindered group containing at least one substituent or ring in the α or β position relative to the nitrogen atom to which it is attached.

For the purposes of the invention, R₉ is a hindered group containing at least one substituent or ring in the α or β position relative to the nitrogen atom to which it is attached.

In a particular embodiment, in formulae (VI) and (VII) of the invention, Re₈ and R₉ are, independently of each other, a hindered group represented by formula (VIII) below:

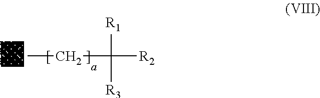

in which:
R₁, R₂, R₃ and a are as defined previously,
the symbol ▪ represents the point of attachment to the nitrogen atom.

Even more particularly, in formulae (VI) and (VII) of the invention, R₈ and R₉ are, independently of each other, a hindered group represented by one of the formulae (VIIIa), (VIIIb) or (VIIIc) below:

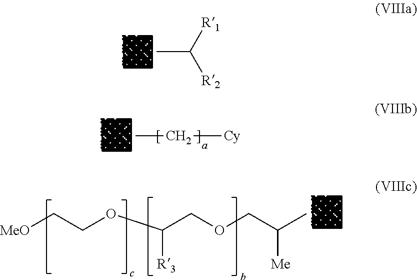

in which:
R′₁, R′₂, R′₃, Cy, a, b and c are as defined previously,
the symbol ▪ represents the point of attachment to the nitrogen atom.

In a particular embodiment, in formula (IV) of the oligomer of the invention, U₁ and U₄ are, independently of each other, a urethane bond represented by formula (IX) below:

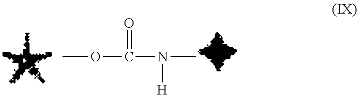

the symbol ★ represents the point of attachment to group L₁ or L₂,
the symbol [symbol] represents the point of attachment to group I,
p>0 and U₂ and U₃ are, independently of each other, a urea bond represented by formula (X) below:

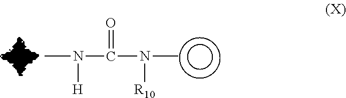

in which:
R₁₀ is other than H, and preferably R₁₀ is a hindered group,
the symbol ⊚ represents the point of attachment to group A,
the symbol [symbol] represents the point of attachment to group I.

For the purposes of the invention, R₁₀ is a hindered group containing at least is one substituent or ring in the α or β position relative to the nitrogen atom to which it is attached.

More particularly, in formula (X) of the invention, R₁₀ is a hindered group chosen from one of the groups of formulae (VIII), (VIIIa), (VIIIb) or (VIIIc) as defined previously, or a group represented by one of the formulae (XI) or (XII) below:

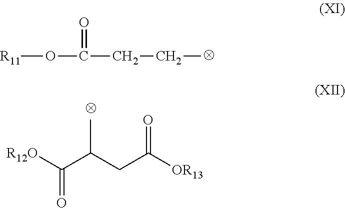

in which:
R₁₁ is chosen from alkyl, cycloalkyl, heterocycloalkyl, aryl, heteroaryl and alkyl groups containing at least one heteroatom, polyester, or combinations thereof,
R₁₂ and R₁₃ are, independently of each other, an alkyl group, and the symbol ⊗ represents the point of attachment to the nitrogen atom.

In this particular embodiment, when U₁ et U₄ are, independently of each other, a urethane bond, in formula (IV) of the oligomer of the invention, r, L₁, L₂, P and o may be as defined below:
r is equal to 0,
L₁ and L₂ are, independently of each other, [●]ₒ—P-♦,
P is the residue of a polyol, and preferably P is an optionally alkoxylated or esterified alkylene,
o is an integer from 1 to 5,
the symbol ● represents a point of attachment to an Acr group,
symbol ♦ represents the point of attachment to the U₁ or U₄ group.

In this particular embodiment, when U₁ and U₄ are, independently of each other, a urethane bond, in formula (IV) of the oligomer of the invention, A may be the residue of a hindered polyamine, and in particular A is chosen from one of the groups of formulae (XIIIa), (XIIIb), (XIIIc), (XIIId) or (XIIIe) below:

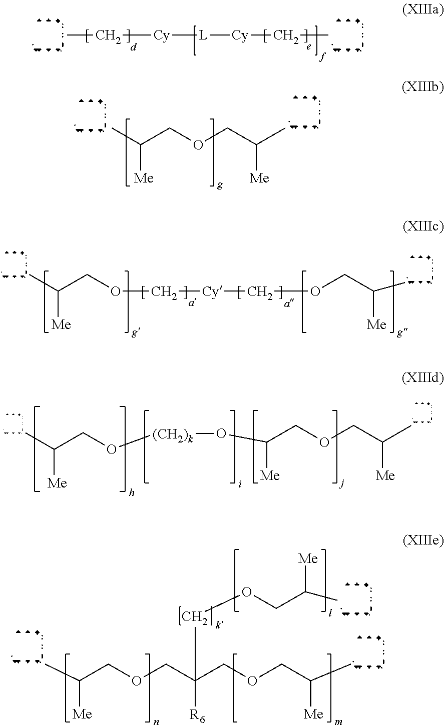

in which:
Cy, Cy′, R₆, L, a′, a″, d, e, f, g, g′, g″, h, i, j, k, k′, l, m and n are as defined previously,
the symbol □ represents the point of attachment to U₂ or U₃.

In this particular embodiment, when U₁ and U₄ are, independently of each other, a urethane bond, in formula (IV) of the oligomer of the invention, A may be the residue of an unhindered polyamine, and in particular A may be chosen from one of the groups of formulae (XIVa), (XIVb), (XIVc), (XIVd), (XIVe) or (XIVf) below:

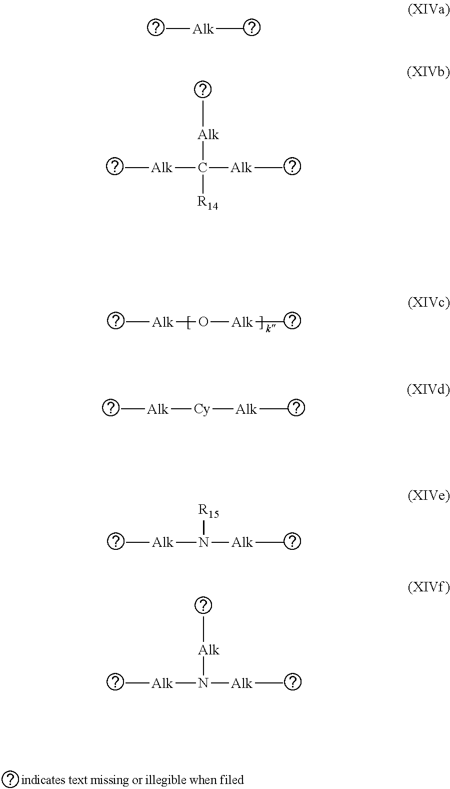

in which:
Alk is alkylene, optionally substituted with one or more groups independently chosen from alkyl and alkenyl,
Cy is a ring, optionally substituted with one or more groups independently chosen from alkyl and alkenyl,
R₁₄ and R₁₅ are, independently of each other, H or an alkyl group,
k″ is an integer from 1 to 50,
the symbol □ represents the point of attachment to U₂ or U₃, and more particularly, A is the residue of an unhindered polyamine chosen from: ethylenediamine, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,12-diaminododecane, diethylenetriamine, tris(2-aminoethyl)amine, tris(2-aminopropyl)amine, 2-(aminomethyl)-2-methyl-1,3-propanediamine, N-(2-aminoethyl)-N-methylethylenediamine, a polyether diamine based on polyethylene glycol preferably having a weight-average molecular weight M_{w} ranging from 200 to 10 000 g·mol⁻¹ (Jeffamine® EDR), a diamine based on a fatty acid dimer preferably containing from 20 to 40 carbon atoms (Priamine® 1071, Priamine® 1073, Priamine® 1074).

For the purposes of the invention, an alkenyl is an alkyl comprising at least one carbon-carbon double bond.

In one embodiment, when U₁ and U₄ are, independently of each other, a urea or urethane bond, in formula (IV) of the oligomer of the invention, r, L₁, L₂, P and o may be as defined below:
r is equal to 1,
L₁ and L₂ are, independently of each other, [●]ₒ—P—O—C(═O)—CH₂—CH₂-♦,
P is the residue of a polyol, and preferably P is an optionally alkoxylated or esterified alkylene,
the symbol ● represents a point of attachment to an Acr group,
the symbol ♦ represents the point of attachment to the group U₁ or U₄.

In this particular embodiment, when U₁ and U₄ are, independently of each other, a urea or urethane bond, in formula (IV) of the oligomer of the invention, A can be the residue of a hindered polyamine resulting from an aza-Michael reaction between a polyacrylate and a hindered primary monoamine with a stoichiometric excess of acryloyloxy groups relative to the primary amine groups, and more particularly A corresponds to formula (XV) below:

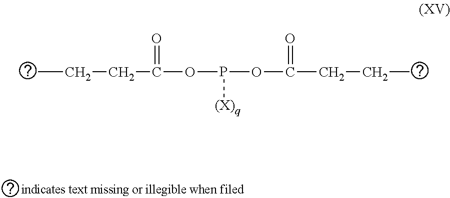

in which P is the residue of a polyol, and preferably P is an optionally alkoxylated or esterified alkylene,
q is equal to 0, 1, 2 or 3,
X is absent or X is —O—C(═O)—CH₂—CH₂—U₂-I-U₁—CH₂—CH₂—C(═O)—O—P′-[Acr]ₒ,
U₁, U₂, I, Acr and o are as defined previously,
P′ is the residue of a polyol, and preferably P′ is an optionally alkoxylated or esterified alkylene,
the symbol □ represents the point of attachment to U₂ or U₃.

For the purposes of the invention, a polyacrylate is a compound containing at least two acryloyloxy groups.

Preferably, in formula (IV) of the oligomer of the invention, P and P′ are, independently of each other, the residue of a polyol chosen from: ethylene glycol, 1,2- or 1,3-propylene glycol, 1,2-, 1,3- or 1,4-butylene glycol, 1,5-pentanediol, 1,6-hexanediol, 1,8-octanediol, 1,9-nonanediol, 1,10-decanediol, 1,12-dodecanediol, 2-methyl-1,3-propanediol, 2,2-diethyl-1,3-propanediol, 3-methyl-1,5-pentanediol, 3,3-dimethyl-1,5-pentanediol, neopentyl glycol, 2,4-diethyl-1,5-pentanediol, cyclohexanediol, cyclohexane-1,4-dimethanol, norbornenedimethanol, norbornanedimethanol, tricyclodecanediol, tricyclodecanedimethanol, bisphenol A, B, F or S, hydrogenated bisphenol A, B, F or S, trimethylolmethane, trimethylolethane, trimethylolpropane, bis(trimethylolpropane), triethylolpropane, pentaerythritol, di(pentaerythritol), glycerol, di-, tri- or tetraglycerol, polyglycerol, di-, tri- or tetraethylene glycol, di-, tri- or tetrapropylene glycol, di-, tri- or tetrabutylene glycol, a polyethylene glycol preferably having a weight-average molecular weight Mw ranging from 200 to 10 000 g·mol⁻¹, a polypropylene glycol preferably having a weight-average molecular weight Mw ranging from 200 to 10 000 g·mol⁻¹, a polytetramethylene glycol preferably having a weight-average molecular weight Mw ranging from 200 to 10 000 g·mol⁻¹, a poly(ethylene glycol-co-propylene glycol) preferably having a weight-average molecular weight M_{w} ranging from 200 to 10 000 g·mol⁻¹, an alditol (i.e. erythritol, threitol, arabitol, xylitol, ribitol, mannitol, sorbitol, galactitol, fucitol or iditol), a dianhydrohexitol (i.e. isosorbide, isomannide or isoidide), tris(2-hydroxyethyl) isocyanurate, a polybutadiene polyol preferably having a weight-average molecular weight M_{w} ranging from 200 to 10 000 g·mol⁻¹, a polyester polyol preferably having a weight-average molecular weight M_{w} ranging from 200 to 10 000 g·mol⁻¹, a polyether polyol preferably having a weight-average molecular weight M_{w} ranging from 200 to 10 000 g·mol⁻¹, a polyorganosiloxane polyol preferably having a weight-average molecular weight M_{w} ranging from 200 to 10 000 g·mol⁻¹, a polycarbonate polyol preferably having a weight-average molecular weight M_{w} ranging from 200 to 10 000 g·mol⁻¹, and also the alkoxylated (e.g. ethoxylated and/or propoxylated) derivatives thereof, and the derivatives obtained by ring-opening polymerization of a lactone (e.g. ε-caprolactone) initiated with one of the abovementioned polyols.

Another subject of the present invention relates to a polymerizable composition comprising at least one oligomer as defined according to the present invention and optionally at least one other ethylenically unsaturated compound.

For the purposes of the invention, an “ethylenically unsaturated compound” means a compound which comprises a polymerizable carbon-carbon double bond. A polymerizable carbon-carbon double bond is a carbon-carbon double bond that can react with another carbon-carbon double bond in a polymerization reaction. A polymerizable carbon-carbon double bond is generally within a group chosen from acrylate (including cyanoacrylate), methacrylate, acrylamide, methacrylamide, styrene, maleate, fumarate, itaconate, allyl, propenyl, vinyl and corresponding combinations, preferably chosen from acrylate, methacrylate and vinyl, more preferably chosen from acrylate and methacrylate. Carbon-carbon double bonds in a phenyl ring are not considered as polymerizable carbon-carbon double bonds.

In one embodiment, the ethylenically unsaturated compound may be chosen from a (meth)acrylate-functionalized monomer, a (meth)acrylate-functionalized oligomer and corresponding mixtures. In particular, the ethylenically unsaturated compound comprises a (meth)acrylate-functionalized monomer.

The total amount of ethylenically unsaturated compound in the polymerizable composition may be from 0 to 90%, in particular 5% to 85%, more particularly 10% to 80%, by weight relative to the total weight of the composition. In particular, the polymerizable composition may comprise 0 to 60%, or 5% to 60% or 10% to 60% or 15% to 60% or 20% to 60% by weight of ethylenically unsaturated compound relative to the weight of the composition. As a variant, the polymerizable composition may comprise 50-80%, or 55-80% or 60-80%, by weight of ethylenically unsaturated compound relative to the weight of the composition.

As used herein, the term “(meth)acrylate-functionalized monomer” means a monomer comprising at least one (meth)acryloyloxy group, in particular an acryloyloxy group. The term “(meth)acrylate-functionalized oligomer” means an oligomer comprising a (meth)acryloyloxy group, in particular an acryloyloxy group. The term “(meth)acryloyloxy group” includes acryloyloxy groups (—O—CO—CH═CH₂) and methacryloyloxy groups (—O—CO—C(CH₃)═CH₂).

In one embodiment, the ethylenically unsaturated compound comprises a monomer functionalized with (meth)acrylate. The ethylenically unsaturated compound may comprise a mixture of (meth)acrylate-functionalized monomers.

The (meth)acrylate-functionalized monomer may have a molecular weight of less than 600 g/mol, in particular from 100 to 550 g/mol, more particularly from 200 to 500 g/mol.

The (meth)acrylate-functionalized monomer may contain 1 to 6 (meth)acryloyloxy groups, in particular 1 to 4 (meth)acryloyloxy groups.

The (meth)acrylate-functionalized monomer may comprise a mixture of (meth)acrylate-functionalized monomers having different functionalities. For example, the (meth)acrylate-functionalized monomer may comprise a mixture of a (meth)acrylate-functionalized monomer containing a single acryloyloxy or methacryloyloxy group per molecule (referred to herein as “mono(meth)acrylate-functionalized compounds”) and a (meth)acrylate-functionalized monomer containing two or more, preferably two or three, acryloyloxy and/or methacryloyloxy groups per molecule.

In one embodiment, the (meth)acrylate-functionalized monomer comprises a mono(meth)acrylate-functionalized monomer. The mono(meth)acrylate-functionalized monomer may advantageously function as a reactive diluent and reduce the viscosity of the polymerizable composition of the invention.

Examples of suitable mono(meth)acrylate-functionalized monomers include, without being limited to, mono(meth)acrylate esters of aliphatic alcohols (the aliphatic alcohol may be straight-chained, branched or alicyclic and may be a monoalcohol, dialcohol or polyalcohol, on condition that a single hydroxyl group is esterified with a (meth)acrylic acid); mono(meth)acrylate esters of aromatic alcohols (such as phenols, including alkylated phenols); mono(meth)acrylate esters of alkylaryl alcohols (such as benzyl alcohol); mono(meth)acrylate esters of oligomeric and polymeric glycols (such as diethylene glycol, triethylene glycol, dipropylene glycol, tripropylene glycol, polyethylene glycol and polypropylene glycol); mono(meth)acrylate esters of monoalkyl ethers of glycols and oligoglycols; mono(meth)acrylate esters of alkoxylated (for example ethoxylated and/or propoxylated) aliphatic alcohols (the aliphatic alcohol may be straight-chained, branched or alicyclic and may be a monoalcohol, dialcohol or polyalcohol, on condition that only one hydroxyl group of the alkoxylated aliphatic alcohol is esterified with a (meth)acrylic acid); mono(meth)acrylate esters of alkoxylated (for example ethoxylated and/or propoxylated) aromatic alcohols (such as alkoxylated phenols); caprolactone mono(meth)acrylates; and the like.

The following compounds are specific examples of mono(meth)acrylate-functionalized monomers that are suitable for use in the polymerizable compositions of the present invention: methyl (meth)acrylate; ethyl (meth)acrylate; n-propyl (meth)acrylate; n-butyl (meth)acrylate; isobutyl (meth)acrylate; n-hexyl (meth)acrylate; 2-ethylhexyl (meth)acrylate; n-octyl (meth)acrylate; isooctyl (meth)acrylate; n-decyl (meth)acrylate; n-dodecyl (meth)acrylate; tridecyl (meth)acrylate; tetradecyl (meth)acrylate; hexadecyl (meth)acrylate; 2-hydroxyethyl (meth)acrylate; 2-hydroxypropyl (meth)acrylate and 3-hydroxypropyl (meth)acrylate; 2-methoxyethyl (meth)acrylate; 2-ethoxyethyl (meth)acrylate; 2-ethoxypropyl (meth)acrylate and 3-ethoxypropyl (meth)acrylate; tetrahydrofurfuryl (meth)acrylate; alkoxylated tetrahydrofurfuryl (meth)acrylate; 2-(2-ethoxyethoxy)ethyl (meth)acrylate; cyclohexyl (meth)acrylate; glycidyl (meth)acrylate; isodecyl (meth)acrylate; lauryl (meth)acrylate; 2-phenoxyethyl (meth)acrylate; alkoxylated phenol (meth)acrylates; alkoxylated nonylphenol (meth)acrylates; cyclic trimethylolpropane formal (meth)acrylate; isobornyl (meth)acrylate; tricyclodecanemethanol (meth)acrylate; tert-butylcyclohexanol (meth)acrylate; trimethylcyclohexanol (meth)acrylate; diethylene glycol monomethyl ether (meth)acrylate; diethylene glycol monobutyl ether (meth)acrylate; triethylene glycol monoethyl ether (meth)acrylate; ethoxylated lauryl (meth)acrylate; methoxy polyethylene glycol (meth)acrylates; hydroxyl ethyl butyl urethane (meth)acrylates; 3-(2-hydroxyalkyl)oxazolidinone (meth)acrylates; and corresponding combinations.

In one embodiment, the (meth)acrylate-functionalized monomer may comprise a (meth)acrylate-functionalized monomer containing two or more (meth)acryloyloxy groups per molecule.

Examples of suitable (meth)acrylate-functionalized monomers containing two or more groups of (meth)acryloyloxy type per molecule include acrylate and methacrylate esters of polyols (organic compounds containing two or more hydroxyl groups per molecule, for example 2 to 6). Specific examples of suitable polyols are as defined previously for P and P′. Such polyols may be totally or partially esterified (with a (meth)acrylic acid, a (meth)acrylic anhydride, a (meth)acryloyl chloride or the like), on condition that they contain at least two functional groups of (meth)acryloyloxy type per molecule.

Examples of (meth)acrylate-functionalized monomers containing two or more (meth)acryloyloxy groups per molecule may comprise bisphenol A di(meth)acrylate; hydrogenated bisphenol A di(meth)acrylate; ethylene glycol di(meth)acrylate; diethylene glycol di(meth)acrylate; triethylene glycol di(meth)acrylate; tetraethylene glycol di(meth)acrylate; polyethylene glycol di(meth)acrylate; propylene glycol di(meth)acrylate; dipropylene glycol di(meth)acrylate; tripropylene glycol di(meth)acrylate; tetrapropylene glycol di(meth)acrylate; polypropylene glycol di(meth)acrylate; polytetramethylene glycol di(meth)acrylate; 1,2-butanediol di(meth)acrylate; 2,3-butanediol di(meth)acrylate; 1,3-butanediol di(meth)acrylate; 1,4-butanediol di(meth)acrylate; 1,5-pentanediol di(meth)acrylate; 1,6-hexanediol di(meth)acrylate; 1,8-octanediol di(meth)acrylate; 1,9-nonanediol di(meth)acrylate; 1,10-decanediol di(meth)acrylate; 1,12-dodecanediol di(meth)acrylate; neopentyl glycol di(meth)acrylate; 2-methyl-2,4-pentanediol di(meth)acrylate; polybutadiene di(meth)acrylate; cyclohexane-1,4-dimethanol di(meth)acrylate; tricyclodecane dimethanol di(meth)acrylate; metal di(meth)acrylates; modified metal di(meth)acrylates; glycerol di(meth)acrylate; glycerol tri(meth)acrylate; trimethylolethane tri(meth)acrylate; trimethylolethane di(meth)acrylate; trimethylolpropane tri(meth)acrylate; trimethylolpropane di(meth)acrylate; pentaerythritol di(meth)acrylate; pentaerythritol tri(meth)acrylate; pentaerythritol tetra(meth)acrylate, bis(trimethylolpropane) di(meth)acrylate; bis(trimethylolpropane) tri(meth)acrylate; bis(trimethylolpropane) tetra(meth)acrylate, sorbitol penta(meth)acrylate; di(pentaerythritol) tetra(meth)acrylate; di(pentaerythritol) penta(meth)acrylate; di(pentaerythritol) hexa(meth)acrylate; tris(2-hydroxyethyl) isocyanurate tri(meth)acrylate; and also alkoxylated (for example ethoxylated and/or propoxylated) derivatives thereof; and mixtures thereof.

The polymerizable composition of the invention may comprise 0 to 90%, in particular 5% to 85%, more particularly 10% to 80%, by weight of (meth)acrylate-functionalized monomer relative to the weight of the composition. In particular, the polymerizable composition may comprise 0 to 60%, or 5% to 60%, or 10% to 60%, or 15% to 60%, or 20% to 60% by weight of (meth)acrylate-functionalized monomer, relative to the weight of the composition. As a variant, the polymerizable composition may comprise 50% to 80%, or 55% to 80%, or 60% to 80%, by weight of (meth)acrylate-functionalized monomer relative to the weight of the composition.

In one embodiment, the ethylenically unsaturated compound comprises a (meth)acrylate-functionalized oligomer. The ethylenically unsaturated compound may comprise a mixture of (meth)acrylate-functionalized oligomers.

The (meth)acrylate-functionalized oligomer may be chosen so as to increase the flexibility, strength and/or modulus, among other attributes, of a cured polymer prepared using the polymerizable composition of the present invention.

The (meth)acrylate-functionalized oligomer may contain 1 to 18 (meth)acryloyloxy groups, in particular 2 to 6 (meth)acryloyloxy groups, more particularly 2 to 6 acryloyloxy groups.

The (meth)acrylate-functionalized oligomer may have a number-average molecular weight of greater than or equal to 600 g/mol, in particular 800 to 15 000 g/mol, more particularly 1000 to 5000 g/mol.

In particular, the (meth)acrylate-functionalized oligomers may be chosen from the group consisting of (meth)acrylate-functionalized urethane oligomers (sometimes also referred to as “urethane (meth)acrylate oligomers”, “polyurethane (meth)acrylate oligomers” or “carbamate (meth)acrylate oligomers”), (meth)acrylate-functionalized epoxy oligomers (sometimes also referred to as “epoxy (meth)acrylate oligomers”), (meth)acrylate-functionalized polyether oligomers (sometimes also referred to as “polyether (meth)acrylate oligomers”), (meth)acrylate-functionalized polydiene oligomers (sometimes also referred to as “polydiene (meth)acrylate oligomers”), (meth)acrylate-functionalized polycarbonate oligomers (sometimes also referred to as “polycarbonate (meth)acrylate oligomers”), and (meth)acrylate-functionalized polyester oligomers (sometimes also referred to as “polyester (meth)acrylate oligomers”) and corresponding mixtures.

Polyester (meth)acrylate oligomers given by way of example comprise products of reaction of acrylic or methacrylic acid or corresponding synthetic mixtures or equivalents with hydroxy-terminated polyester polyols. The reaction process can be performed so that all, or essentially all, the hydroxyl groups of the polyester polyol have been (meth)acrylated, particularly in cases where the polyester polyol is difunctional. Polyester polyols may be prepared by polycondensation reactions of polyhydroxy-functionalized components (in particular, diols) and poly(carboxylic acid)-functionalized compounds (in particular, dicarboxylic acids and anhydrides). The polyhydroxy-functionalized and poly(carboxylic acid)-functionalized components may each have linear, branched, cycloaliphatic or aromatic structures and may be used individually or as mixtures.

Examples of suitable epoxy (meth)acrylates comprise products of reaction of acrylic or methacrylic acid or corresponding mixtures with an epoxy resin (polyglycidyl ether or ester). The epoxy resin may, in particular, be chosen from bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resin, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexanecarboxylate, 2-(3,4-epoxycyclohexyl-5,5-spiro-3,4-epoxy)cyclohexane-1,4-dioxane, bis(3,4-epoxycyclohexylmethyl)adipate, vinylcyclohexene oxide, 4-vinylepoxycyclohexane, bis(3,4-epoxy-6-methylcyclohexylmethyl)adipate, 3,4-epoxy-6-methylcyclohexyl-3′,4′-epoxy-6′-methylcyclohexanecarboxylate, methylenebis(3,4-epoxycyclohexane), dicyclopentadiene diepoxide, ethylene glycol bis(3,4-epoxycyclohexylmethyl) ether, ethylenebis(3,4-epoxycyclohexanecarboxylate), 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ether, polyglycidyl ethers of a polyether polyol obtained by the addition of one or more alkylene oxides to an aliphatic polyhydric alcohol, such as ethylene glycol, propylene glycol and glycerol, diglycidyl esters of long-chain aliphatic dibasic acids, monoglycidyl ethers of aliphatic higher alcohols, monoglycidyl ethers of phenol, cresol, butylphenol, or polyether alcohols obtained by the addition of alkylene oxide to these compounds, glycidyl esters of higher fatty acids, epoxidized soybean oil, epoxybutylstearic acid, epoxyoctylstearic acid, epoxidized linseed oil, an epoxidized polybutadiene, and the like.

Suitable polyether (meth)acrylate oligomers include, without being limited to, condensation reaction products of acrylic or methacrylic acid or corresponding mixtures or synthetic equivalents with polyetherols which are polyether polyols (such as a polyethylene glycol, a polypropylene glycol or a polytetramethylene glycol). Suitable polyetherols may be linear or branched substances containing ether bonds and terminal hydroxyl groups. Polyetherols may be prepared by ring-opening polymerization of cyclic ethers such as tetrahydrofuran or alkylene oxides (for example ethylene oxide and/or propylene oxide) with a starting molecule. Suitable starting molecules include water, polyhydroxy-functionalized materials, polyester polyols and amines.

Polyurethane (meth)acrylate oligomers (sometimes also referred to as “urethane (meth)acrylate oligomers”) that are suitable for use in the polymerizable compositions of the present invention comprise urethanes based on aliphatic, cycloaliphatic and/or aromatic polyester polyols and polyether polyols and aliphatic, cycloaliphatic and/or aromatic polyester diisocyanates and polyether diisocyanates capped with terminal (meth)acrylate groups. Suitable polyurethane (meth)acrylate oligomers comprise, for example, aliphatic polyester-based urethane diacrylate and tetraacrylate oligomers, aliphatic polyether-based urethane diacrylate and tetraacrylate oligomers, and also aliphatic polyester/polyether-based urethane diacrylate and tetraacrylate oligomers.

Polyurethane (meth)acrylate oligomers may be prepared by reacting aliphatic, cycloaliphatic or aromatic polyisocyanates (for example diisocyanate, triisocyanate) with polyester polyols, polyether polyols, polycarbonate polyols, polycaprolactone polyols, polyorganosiloxane polyols (for example polydimethylsiloxane polyols), or polydiene polyols (for example polybutadiene polyols), terminated with an OH group, or corresponding combinations, to form isocyanate-functionalized oligomers which are then reacted with hydroxy-functionalized (meth)acrylates such as hydroxyethyl acrylate or hydroxyethyl methacrylate to provide terminal (meth)acrylate groups. For example, polyurethane (meth)acrylate oligomers may contain two, three, four or more (meth)acrylate functional groups per molecule. Other orders of addition may also be performed to prepare polyurethane (meth)acrylate, as is known in the prior art. For example, the hydroxy-functionalized (meth)acrylate may first be reacted with a polyisocyanate to obtain an isocyanate-functionalized (meth)acrylate, which may then be reacted with an OH-terminated polyester polyol, polyether polyol, polycarbonate polyol, polycaprolactone polyol, polydimethylsiloxane polyol or polybutadiene polyol, or a corresponding combination. In yet another embodiment, a polyisocyanate may first be reacted with a polyol, including any one of the previously mentioned polyol types, to obtain an isocyanate-functionalized polyol, which is then reacted with a hydroxy-functionalized (meth)acrylate to give a polyurethane (meth)acrylate. As a variant, all the components may be combined and reacted at the same time.

Suitable acrylic (meth)acrylate oligomers (sometimes also referred to in the prior art as “acrylic oligomers”) comprise oligomers which can be described as substances containing an oligomeric acrylic backbone which is functionalized with one or more (meth)acrylate groups (which may be at a termination of the oligomer or pendant on the acrylic backbone). The acrylic backbone may be a homopolymer, a random copolymer or a block copolymer composed of repeating units of acrylic-type monomers. The acrylic-type monomers may be any monomeric (meth)acrylates such as C1-C6 alkyl (meth)acrylates and also functionalized (meth)acrylates such as (meth)acrylates bearing hydroxyl, carboxylic acid and/or epoxy groups. Acrylic (meth)acrylate oligomers may be prepared by means of any procedure known in the prior art, such as oligomerization of monomers, at least some of which are functionalized with hydroxyl, carboxylic acid and/or epoxy groups (for example hydroxyalkyl (meth)acrylates, a (meth)acrylic acid, a glycidyl (meth)acrylate) to obtain a functionalized oligomer intermediate, which is then reacted with one or more (meth)acrylate-containing reagents to introduce the desired (meth)acrylate functional groups.

The polymerizable composition of the invention may comprise 0 to 90%, in particular 5% to 85%, more particularly 10% to 80%, by weight of (meth)acrylate-functionalized oligomer relative to the weight of the composition. In particular, the polymerizable composition may comprise 0 to 60%, or 5% to 60%, or 10% to 60%, or 15% to 60%, or 20% to 60%, by weight of (meth)acrylate-functionalized oligomer relative to the weight of the composition. As a variant, the polymerizable composition may comprise 50% to 80%, or 55% to 80%, or 60% to 80%, by weight of (meth)acrylate-functionalized oligomer relative to the weight of the composition.

The polymerizable composition of the invention may also advantageously comprise a free-radical or ionic polymerization initiator, and more particularly a photoinitiator or a peroxide.

The photoinitiator may be a free-radical photoinitiator, in particular a free-radical photoinitiator having Norrish I-type activity and/or Norrish II-type activity, more particularly a free-radical photoinitiator having Norrish I-type activity.

Non-limiting types of free-radical photoinitiators that are suitable for use in the polymerizable compositions of the present invention include, for example, benzoins, benzoin ethers, acetophenones, α-hydroxyacetophenones, benzil, benzil ketals, anthraquinones, phosphine oxides, acylphosphine oxides, a-hydroxy ketones, phenylglyoxylates, α-amino ketones, benzophenones, thioxanthones, xanthones, acridine derivatives, phenazene derivatives, quinoxaline derivatives, triazine compounds, benzoyl formates, aromatic oximes, metallocenes, acylsilyl or acylgermanyl compounds, camphorquinones, corresponding polymer derivatives, and corresponding mixtures.

Examples of suitable free-radical photoinitiators include, without being limited to, 2-methylanthraquinone, 2-ethylanthraquinone, 2-chloroanthraquinone, 2-benzyanthraquinone, 2-t-butylanthraquinone, 1,2-benzo-9,10-anthraquinone, benzil, benzoins, benzoin ethers, benzoin, benzoin methyl ether, benzoin ethyl ether, benzoin isopropyl ether, α-methylbenzoin, α-phenylbenzoin, Michler's ketone, acetophenones such as 2,2-dialkoxybenzophenones and 1-hydroxyphenyl ketones, benzophenone, 4,4′-bis(diethylamino)benzophenone, acetophenone, 2,2-diethyloxyacetophenone, diethyloxyacetophenone, 2-isopropylthioxanthone, thioxanthone, diethylthioxanthone, 1,5-acetonaphthylene, benzil ketone, a-hydroxy keto, 2,4,6-trimethylbenzoyldiphenylphosphine oxide, benzil dimethyl ketal, 2,2-dimethoxy-1,2-diphenylethanone, 1-hydroxycyclohexyl phenyl ketone, 2-methyl-1-[4-(methylthio)phenyl]-2-morpholinopropanone, 1,2-hydroxy-2-methyl-1-phenylpropanone, oligomeric a-hydroxy ketone, benzoylphosphine oxides, phenylbis(2,4,6-trimethylbenzoyl)phosphine oxide, ethyl(2,4,6-trimethylbenzoyl)phenyl phosphinate, anisoin, anthraquinone, anthraquinone-2-sulfonic acid sodium salt monohydrate, (benzene)tricarbonylchromium, benzil, benzoin isobutyl ether, benzophenone/1-hydroxycyclohexyl phenyl ketone 50/50 mixture, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, dibenzosuberenone, 4,4′-dihydroxybenzophenone, 2,2-dimethoxy-2-phenylacetophenone, 4-(dimethylamino)benzophenone, 4,4′-dimethylbenzil, 2,5-dimethylbenzophenone, 3,4-dimethylbenzophenone, diphenyl(2,4,6-trimethylbenzoyl)phosphine oxide/2-hydroxy-2-methylpropiophenone 50/50 mixture, 4′-ethoxyacetophenone, 2,4,6-trimethylbenzoyldiphenylphosphine oxide, phenylbis(2,4,6-trimethylbenzoyl)phosphine oxide, ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, methylbenzoyl formate, 2-methyl-4′-(methylthio)-2-morpholinopropiophenone, phenanthrenequinone, 4′-phenoxyacetophenone, (cumene)cyclopentadienyliron(II) hexafluorophosphate, 9,10-diethoxyanthracene and 9,10-dibutoxyanthracene, 2-ethyl-9,10-dimethoxyanthracene, thioxanthen-9-one and corresponding combinations.

In particular, the photoinitiator may be a benzophenone (such as SpeedCure® BP, SpeedCure® 7005, SpeedCure® 7006), a thioxanthone (such as SpeedCure® 7010, SpeedCure® ITX), an a-hydroxyacetophenone (such as SpeedCure® 73), an acylphosphine oxide (such as SpeedCure® BPO, SpeedCure® TPO, SpeedCure® TPO-L). Preferably, the photoinitiator is an a-hydroxyacetophenone or an acylphosphine oxide.

The polymerizable composition of the invention may notably comprise 0 to 20%, in particular 0.1% to 15%, more particularly 1% to 10% by weight of photoinitiator relative to the weight of the composition.

In addition, the polymerizable composition of the invention may comprise other additives chosen from: antioxidants, photostabilizers, light absorbers, polymerization inhibitors, antifoams, antistatic agents, leveling agents, dispersants (wetting agents, surfactants), slip agents, adhesion promoters, lubricants, pigments, fillers, chain-transfer agents, rheological agents (thixotropic agents, thickeners), matting agents, opacifiers, impact-resistance agents, waxes.

Preferably, the polymerizable composition of the invention is a composition for inks, coatings (notably protective coatings, electrical insulation coatings, decorative coatings or coatings reactive to external stimuli), materials filled with fibrous or particulate reinforcements which may be carbon nanotubes or graphite (notably putty, chemical dowel, artificial stone, dental filling or composite), an adhesive, molding, ink plate or electrode binder composition, or a composition for additive manufacturing, in particular for the 3D or 4D printing of objects.

For the purposes of the invention, an ink plate is a flexible photopolymer plate intended for transferring ink to the support to be printed in rotary letterpress printing or flexography.

Additive manufacturing, also known as 3D printing, consists in creating a point-by-point (volumetric/three-dimensional) object (called voxels by analogy with pixels in conventional two-dimensional printing) from a digital model containing the properties associated with the geometry of the object to be produced (mesh of points or surfaces) and optionally the parameters of the materials to be used, or by selectively modifying the properties of a soft medium at these points, for example by solidification (polymerization) from a vat of liquid resin, or by agglomeration/sintering/melting/resolidification from a bed of powder, or by selectively depositing the material at different points on a surface (also known as a layer, and generally flat), either continuously (by extrusion) or discontinuously (by inkjet), and doing so surface after surface. The surfaces can be supplemented one under the other or one on top of the other, and also from the center outward, generally starting from a printing support, the unmodified material itself possibly being the support. The general principles of 3D printing are defined in the standard ISO/ASTM 52900:2015. Printing a 4D object may be defined as printing a 3D object that is capable of being transformed over time. Thus, 4D printing is the process by which a 3D printed object can modify its own structure and change form under the impulse of external energy such as temperature, light or other environmental stimuli.

Another subject of the present invention relates to a process for manufacturing a crosslinked product, comprising a step of crosslinking a polymerizable composition as defined according to the present invention, in particular by exposing said composition to radiation, and more particularly to UV, near UV, visible, infrared or near-infrared radiation, or to an electron beam.

More particularly, the process of the invention is directed toward manufacturing a crosslinked product chosen from an ink, a coating (notably a protective coating, an electrical insulation coating, a decorative coating or a coating that is reactive to external stimuli), a material filled with fibrous or particulate reinforcements which may be carbon nanotubes or graphite (notably a putty, a chemical dowel, an artificial stone, a dental filling or a composite), an adhesive, a molded material, an ink plate, an electrode binder, or an object obtained by additive manufacturing, in particular an object obtained by 3D or 4D printing.

Another object of the present invention relates to a process for manufacturing a three-dimensional object, comprising an additive manufacturing step using a polymerizable composition as defined according to the present invention, and in particular a continuous or layer-by-layer printing step.

A crosslinked product obtained by crosslinking a polymerizable composition as defined according to the present invention, or obtained via a process as defined according to the present invention, also forms part of the invention.

The crosslinked product of the invention is advantageously an ink, a coating (notably a protective coating, an electrical insulation coating, a decorative coating or a coating that is reactive to external stimuli), a material filled with fibrous or particulate reinforcements that may be carbon nanotubes or graphite (notably a putty, a chemical dowel, an artificial stone, a dental filling or a composite), an adhesive, a molded material, an ink plate, an electrode binder, or an object obtained by additive manufacturing, in particular an object obtained by 3D or 4D printing.

One of the last objects of the invention is directed toward the use of a polymerizable composition as defined according to the present invention for the production of an ink, a coating (notably a protective coating, an electrically insulating coating, a decorative coating or a coating that is reactive to external stimuli), a material filled with fibrous or particulate reinforcements which may be carbon nanotubes or graphite (notably a putty, a chemical dowel, an artificial stone, a dental filling or a composite), an adhesive, a molded material, an ink plate, an electrode binder, or an object obtained by additive manufacturing, in particular an object obtained by 3D or 4D printing.

The invention is also directed toward the use of an oligomer as defined according to the present invention as a binder in a polymerizable composition.

Finally, the last subject of the invention relates to the use of an oligomer as defined according to the present invention in a composition for additive manufacturing, in particular for the 3D or 4D printing of an object.

In addition to the foregoing provisions, the invention also includes other provisions which will become apparent from the following further description, which relates to examples for the synthesis of oligomers according to the invention, and to the evaluation of the applicative properties of compositions comprising them.

### EXAMPLES

### Measurement Methods:

In the present patent application, the following measurement methods were used:

Measurement of the Brookfield viscosity: measured at 25° C. with a Brookfield DVII+ viscometer equipped with an S34 cylindrical spindle at 10 rpm, according to the standard ISO 2555.

During the Brookfield viscosity measurement, the temperature was kept constant using a water circulation temperature control system.

### Measurement of the Noury Dynamic Viscosity:

The Noury dynamic viscosity corresponds to the travel time, in the liquid to be characterized, of a steel ball subjected to its gravity, according to the standard AFNOR XP T51-213 which specifies in particular the container geometry, the ball diameter (2 mm), and the ball travel distance (104 mm). Under these conditions, the dynamic viscosity is proportional to the travel time of the ball, with a travel time of 1 second corresponding to a viscosity of 0.1 Pa·s.

### Reactivity:

The composition was applied with a filmograph to a thickness of 12 μm onto a contrast card (Penopac charts form 1B® Leneta), and then photo-polymerized by exposure to a 120 W Fusion mercury vapor lamp (Heraeus). The measurement gives the number of passes required under the lamp at minimum speed (5 m/min), to obtain a touch-dry film.

Persoz hardness: according to the standard NF EN ISO 1522.

The Persoz hardness was measured after applying a 100 μm-thick composition onto a glass plate with a filmograph, and then photo-polymerizing by exposure to a 120 W Fusion mercury vapor lamp (Heraeus). The exposure time was controlled by the speed of a conveyor taking the substrate under the lamp at a speed of 8 m/min multiplied by the number of passes. The measurement indicates the time (in seconds) before damping of oscillations (change from 12° to 4° amplitude) of a pendulum in contact with the composition-coated glass plate, after 24 hours of rest in an air-conditioned room at 23° C. and 50% relative humidity.

### Pencil Hardness:

The composition was applied as a 100 μm film onto a glass plate, and then photopolymerized by exposure to a 120 W Fusion mercury vapor lamp (Heraeus). This test enables evaluation of the resistance of the coating to surface scratches. Pencils of decreasing hardness (grades 6H to 6B), held in place by a support, were moved over the test film, in accordance with the standard ASTM D3363:1992, after 24 hours of rest in an air-conditioned room at 23° C. and 50% relative humidity. The first pencil hardness grade not to damage the surface determines the film hardness.

### Flexibility:

The composition is applied as a 100 μm film onto a 25/10 mm thick smooth steel plate (D-46® Q-Panel), and then photopolymerized by exposure to a 120 W Fusion mercury vapor lamp (Heraeus) at a speed of 8 m/min. The coated plate is bent on cylindrical mandrels according to the standard ISO 1519. The result is the value (in mm) of the smallest radius of curvature that can be inflicted on the coating without it cracking or detaching from the support.

Chemical resistance: the composition is applied as a 12 μm film onto a glass plate, and then photopolymerized by exposure to a 120 W Fusion mercury vapor lamp (Heraeus) at a speed of 8 m/min. The coating is then rubbed with a 500 g weight fitted with an acetone-soaked cotton wick, performing back and forth strokes over the coating to be tested. The result is the time (expressed in seconds) after which the film detaches and/or deaggregates from the support, measured using a Taber© 5750 linear abrasimeter.

APHA color: according to the standard ISO 6271:2015.

This test allows evaluation of the color using the platinum-cobalt scale, the term “Pt—Co color” being synonymous with the terms “Hazen color” and “APHA color”.

### Additive Manufacturing:

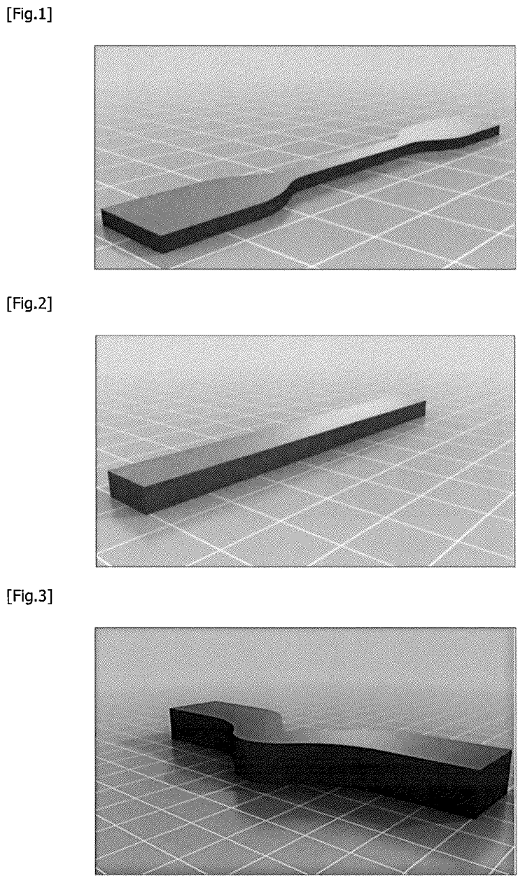

3D objects were printed using the compositions D, E, F, G and H of Example 15 (Table 7), based on the printable object files shown in FIGS. 1-3. The prints were produced on a Photon model 3D printer (LCD printer from Anycubic). The printing program used is indicated in Table 1 below, the adhesion layers being the layers in contact with the platform. The parts obtained after printing were subjected to post-baking under a 395 nm Phoseon 12 W/cm² LED lamp equipped with a conveyor bench with 10 passes at a speed of 5 m/min.

TABLE 1

| | | Pause | Exposure | |
|---|---|---|---|---|
| | Exposure | time | time for | |
| Layer | time per | between | adhesion | Number of |
| thickness | layer | layers | layers | adhesion |
| (um) | (s) | (s) | (s) | layers |
| 100 | 45 | 10 | 120 | 2 |

### Tensile Testing (Elongation, Breaking Stress):

The elongation and breaking stress are measured on a printed object according to the printable object file shown in FIG. 1, using a tensile test according to the standard ISO 527-5A:1993, with a pulling speed suitable for rigid materials (2 mm/min) and flexible materials (500 mm/min).

### Tear Strength:

The tear strength is measured on a printed object according to the printable object file in FIG. 3 according to the standard D624 type C, 2012, with a pulling speed of 500 mm/min.

### Shore Hardness:

The Shore hardness was measured on a printed object according to the printable object file of FIG. 1 according to the standard ISO 868: 2003 with a durometer of Shore A type. Measurements were taken after 5 seconds of contact between the measuring tip and the sample.

### Glass Transition Temperature (Tangent Alpha Ta):

The glass transition temperature was determined by Dynamic Mechanical Analysis (DMA). Measurements of the storage modulus (G′) and the loss modulus (G″) were performed on a Rheometric Scientific RDA III apparatus controlled by RSI Orchestrator software, with a temperature rise from −40° C. to 180° C., at a rate of 3° C./min, by applying a rectangular torsional stress to a sample printed according to the printable object file in FIG. 2, with dimensions of 80*10*4 mm (usable length between jaws adjustable between 1.5 and 4 cm, this value being taken into account in the software's calculation of the moduli), with a typical degree of deformation of 0.05% and a stress frequency of 1 Hz. The samples were first conditioned for at least 24 hours at a temperature of 23° C.±2° C. and 50%±10% relative humidity. The storage modulus values were reported at different temperatures, notably at 25° C. and 150° C. The ratio G″/G′ is called the loss factor or tangent delta (tan delta). The Tg corresponds to the temperature for which the value of this tangent is at its maximum (Tα).

### Determination of the Isocyanate Number (INCO):

The isocyanate number was measured by acid-base back titration of the excess dibutylamine relative to the isocyanate functions, under the following conditions: an exact weight p expressed in grams of sample (about 1 gram) was dissolved in about 10 mL of toluene. After complete dissolution, 15 mL of a solution of dibutylamine having a titre of 0.15 N were added (solution of 20 g of dibutylamine in 1000 mL of toluene: 20 g/L), and then left to react for 15 minutes at room temperature. 100 mL of isopropanol were then added. The excess dibutylamine was assayed with an aqueous hydrochloric acid solution of normal titre N (Eq/l) 0.1 N. The equivalent point was detected with a combination electrode (LiCl Metrohm reference 6.0222.100) slaved to an automatic burette (Metrohm “716 DMS Titrino” automatic titration apparatus), delivering the equivalent volume VE expressed in mL. A blank test (15 mL of dibutylamine solution supplemented with 10 mL of toluene, and then 100 mL of isopropanol) was also performed with an equivalent volume VS expressed in mL. The isocyanate number (I_{NCO}) was calculated using the following formula: I_{NCO} (mgKOH/g)=(VE−VB)*N*56.1/p.

### Determination of the Amine Number (I_{Amine}):

The amine number was measured by direct acid-base titration under the following conditions: an exact sample weight p (expressed in grams) was dissolved in 40 mL of acetic acid. The basicity of the sample was determined using a solution of perchloric acid in acetic acid with a normal titre N (in Eq/l) of 0.1 N. The equivalent point was detected with a glass electrode (filled with a 1 mol/L solution of lithium perchlorate in acetic acid) slaved to an automatic burette (Metrohm “716 DMS Titrino” automatic titration apparatus) delivering the equivalent volume VE expressed in mL. The amine number (I_{Amine}) was calculated using the following formula:

$${I}_{Amine} ( mgKOH / g ) = VE * N * 56.1 / p .$$

### Products and Starting Materials:

The products and starting materials used in the examples below are as follows:
CN981: aliphatic urethane diacrylate oligomer having a weight-average molecular mass of 2200 g/mol (Arkema),
IPGA: 2,2-dimethyl-1,3-dioxolan-4-yl)methyl acrylate monomer obtained by transesterification reaction between isopropylidene glycerol (Augeo SL 191) (Solvay) and methyl acrylate (Arkema), with an acrylate/alcohol mole ratio of 2 to 3, catalyzed with zirconium acetylacetonate (Zr(AcAc)₄) (Sachem),
SR238: 1,6-hexanediol diacrylate (HDDA) monomer with a molecular mass of 226 g/mol (Arkema),
SR355: bis(trimethylolpropane) tetraacrylate monomer with a molecular mass of 466 g/mol (Arkema),
SR595: 1,10-decanediol diacrylate monomer with a molecular mass of 282 g/mol (Arkema),
SR256: 2-(2-ethoxyethoxy)ethyl acrylate monomer with a molecular mass of 188 g/mol (Arkema),
SR444D: pentaerythrityl triacrylate monomer with a molecular mass of 298 g/mol (Arkema),
SR789: tricyclodecanemethanol acrylate monomer with a molecular mass of 220 g/mol (Arkema),
HQME: HydroQuinone Methyl Ether (Sigma-Aldrich),
BHT: Butyl Hydroxy Toluene (Sigma-Aldrich),
Triphenyl phosphite (Sigma-Aldrich),
PTZ: PhenoThiaZine (Sigma-Aldrich),
sec-Butylamine (Sigma-Aldrich),
NMEA: N-MethylEthanolAmine (Sigma-Aldrich),
4,4′-Methylenebis(cyclohexylamine) (Sigma-Aldrich),
HDI: Hexamethylene diisocyanate (Sigma-Aldrich),
IPDI: Isophorone diisocyanate sold under the name Desmodur® I (Covestro),
DEM: DiEthyl Maleate (Sigma-Aldrich),
Jeffamine® ED-600: polyetherdiamine (Huntsman),
TPO-L: ethyl(2,4,6-trimethylbenzoyl)phenyl phosphinate, photoinitiator sold under the reference SpeedCure® TPO-L (Lambson),
SpeedCure® 73: 2-hydroxy-2-methyl-1-phenylpropanone, photoinitiator sold under the reference SpeedCure® 73 (Lambson).

### Example 1: Preparation of a Urea (Meth)Acrylate Oligomer According to the Invention

HDDA SR238 (75.00 g) and HQME (0.120 g) were placed at 23° C. in a reactor equipped with a reflux column, two dropping funnels, a thermometer and an inclined paddle stirrer. sec-Butylamine (19.64 g) was introduced via a dropping funnel over a period of 5 minutes. The reactor was heated to 80° C. over 30 minutes, and then maintained at this temperature for 2 hours. The reactor was then cooled to 40° C. Proton NMR analysis showed the total consumption of the sec-butylamine and the absence of tertiary amine. IPDI (28.00 g) was added via the second dropping funnel over a period of 1 hour. During the introduction, the temperature was maintained below 50° C. by controlling the exothermicity with an ice-water bath. The temperature was maintained at 50° C. for 15 minutes.

### Examples 2 to 8: Preparation of Urea (Meth)Acrylate Oligomers According to the Invention

The same protocol as in Example 1 was repeated, modifying the proportion and nature of the acrylate, amine and isocyanate as indicated in Table 2 below.

TABLE 2

| | Ex. 1 | Ex. 2 | Ex. 3 | Ex. 4 | Ex. 5 | Ex. 6 | Ex. 7 | Ex. 8 |
|---|---|---|---|---|---|---|---|---|
| 1,6-Hexanediol | 75.00 | 75.00 | — | 75.00 | — | — | 120.73 | 145.39 |
| diacrylate (HDDA) | | | | | | | | |
| SR238 (g) | | | | | | | | |
| Bis(trimethylolpropane) | — | — | 75.00 | — | — | — | — | — |
| tetraacrylate | | | | | | | | |
| SR355 (g) | | | | | | | | |
| 1,10-Decanediol | — | — | — | — | 85.37 | 96.39 | — | — |
| diacrylate | | | | | | | | |
| SR595 (g) | | | | | | | | |
| sec-Butylamine (g) | 19.64 | 17.33 | 8.15 | — | 30.05 | 24.93 | — | 44.79 |
| Cyclohexylamine (g) | — | — | — | 26.64 | — | — | 42.88 | — |
| Hexamethylene | — | — | — | — | 34.05 | 28.68 | 36.39 | 25.77 |
| diisocyanate (HDI) (g) | | | | | | | | |
| Isophorone | 28.00 | 25.00 | 12.00 | 28.00 | — | — | — | 34.05 |
| diisocyanate (IPDI) (g) | | | | | | | | |
| [HQME] (ppm) | 1000 | 1000 | 1000 | 1000 | 1000 | 1000 | 1000 | 1000 |
| Viscosity (Pa · s) | 4.6 | 3.4 | 14.5 | 192 | 61 | 19.9 | 37 | 6.4 |
| Viscosity measurement | Brookfield, | Brookfield, | Noury | Noury | Noury | Noury | Noury | Noury |
| method | S34, 10 | S34, 10 | at 50° C. | at 25° C. | at 50° C. | at 25° C. | at 25° C. | at 50° C. |
| | rpm, 25° C. | rpm, 25° C. | | | | | | |

### Example 9: Preparation of a Urethane Aminoacrylate-Acrylate Oligomer According to WO 2016/170264 (Comparative Example)

HDDA SR238 (75.00 g), HQME (0.100 g), BHT (0.050 g), triphenyl phosphite (0.100 g) and PTZ (0.020 g) were placed at 23° C. in a reactor equipped with a reflux column, two dropping funnels, a thermometer and an inclined paddle stirrer. NMEA (17.80 g) was introduced via a dropping funnel over a period of 30 minutes. The reactor was heated to 50° C. over 30 minutes, and then maintained at this temperature for 2 hours. IPDI (21.95 g) was added via the second dropping funnel over a period of 1 hour. The temperature was then brought to 100° C. and maintained at this temperature for 3 hours.

### Example 10: Preparation of a Urea (Meth)Acrylate Oligomer According to the Invention

HDDA SR238 (75.00 g) and HQME (0.120 g) were placed at 23° C. in a reactor equipped with a reflux column, two dropping funnels, a thermometer and an inclined paddle stirrer. sec-Butylamine (17.33 g) was introduced via a dropping funnel over a period of 5 minutes. The reactor was heated to 55° C. over 10 minutes, then to 75° C., and maintained at this temperature for 1 hour. The reactor was then cooled to 40° C. IPDI (21.95 g) was added via the second dropping funnel over a period of 1 hour. During the introduction, the temperature was maintained below 50° C. by controlling the exothermicity with an ice-water bath. The temperature was maintained at 50° C. for 15 minutes.

### Examples 11 to 13: Preparation of Urea (Meth)Acrylate Oligomers According to the Invention

The same protocol as in Example 10 was repeated, modifying the proportion and nature of the amine and of the isocyanate as indicated in Table 3 below.

TABLE 3

| | Ex. 9 | | | | |
|---|---|---|---|---|---|
| | (comparative) | Ex. 10 | Ex. 11 | Ex. 12 | Ex. 13 |
| 1,6-Hexanediol | 75.00 | 75.00 | 75.00 | 75.00 | 75.00 |
| diacrylate (HDDA) | | | | | |
| SR238 (g) | | | | | |
| N-MethylEthanoi- | 17.80 | — | — | — | — |
| Amine (NMEA) (g) | | | | | |
| sec-Butylamine | — | 17.33 | 17.33 | 13.86 | 13.86 |
| Hexamethylene | — | — | 16.61 | — | 16.61 |
| diisocyanate (HDI) | | | | | |
| (g) | | | | | |
| Isophorone | 21.95 | 21.95 | — | 21.95 | — |
| diisocyanate (IPDI) | | | | | |
| (g) | | | | | |

The molar amount of isocyanate functions introduced was constant in all the examples in Table 3, so that they were strictly comparable. The examples could thus be compared in terms of color, viscosity and hardness after application in film form of a mixture consisting of 9.90 g of an exemplified oligomer composition with 0.10 g of the photoinitiator TPO-L. The results obtained are summarized in Table 4 below.

TABLE 4

| | | | Brookfield | | |
|---|---|---|---|---|---|
| | R1 | R2 | viscosity at | | |
| | (amine/ | (isocyanate/ | 25° C. | Persoz | |
| | acrylate | amine | 10 rpm | hardness | Color |
| | mole ratio) | mole ratio) | (Pa · s) | (s) | (APHA) |
| Ex. 9 | 0.30 | 0.83 | 1.0 | 40 | 720 |
| (comparative) | | | | | |
| Ex. 10 | 0.30 | 0.83 | 2.4 | 145 | 31 |
| Ex. 11 | 0.30 | 0.83 | 1.0 | 40 | 24 |
| Ex. 12 | 0.25 | 0.99 | 1.4 | 218 | 19 |
| Ex. 13 | 0.25 | 0.99 | 0.5 | 116 | 16 |

The results presented in Table 4 show that:
The oligomers of the invention are much less colored than that of the prior art (reference).
Examples 10 and 11 show that, for identical R1 and R2, the compromise between viscosity (desired to be as low as possible) and Persoz hardness (desired to be as high as possible) is at least equivalent to that of the reference. Example 11 shows that mechanical properties equivalent to those of the reference can be obtained without the presence of a ring. The comparison between Examples 9 and 11 is proof that the urea function present in the oligomer of the invention is preferable to a urethane function, at equivalent concentration.
Due to the absence of side reactions, the invention offers the possibility of synthesizing oligomers with isocyanate/amine R2 ratios close to 1, which is not possible for the reference. In this case, Examples 12 and 13 show that the compromise between viscosity and Persoz hardness is very clearly in favor of the oligomers of the invention.

### Example 14: Preparation of an Intermediate with Secondary Diamine

2-(2-Ethoxyethoxy)ethyl acrylate SR256 (60.00 g) and HQME (0.100 g) were placed at 23° C. in a reactor equipped with a reflux column, two dropping funnels, a thermometer and an inclined paddle stirrer. 4,4′-Methylenebis(cyclohexylamine) (33.51 g) was introduced via a dropping funnel over a period of 5 minutes. The reactor was heated at 90° C. for 3 hours. The reactor was then cooled to 65° C., and HDDA (20.00 g) was then introduced via the other dropping funnel over 5 minutes. The reactor was then maintained at 65° C. for 1 hour, and then cooled to room temperature.

### Example 15: Preparation of an HDI-Pentaerythrityl Triacrylate Adduct Intermediate

HDI (29.66 g), BHT (0.050 g) and HQME (0.050 g) were placed at 23° C. in a reactor equipped with a reflux column, a dropping funnel, a thermometer and an inclined paddle stirrer. Pentaerythrityl triacrylate SR444D (91.69 g) was introduced via the dropping funnel over 20 minutes. The reactor was heated to 80° C. until an isocyanate number of 82 mgKOH/g was obtained. After cooling to room temperature, the intermediate was stored for 30 minutes (it is never stored for more than 24 hours). During this period, the isocyanate number remains stable: I_{NCO}=80.4 mgKOH/g.

### Eample 16: Preparation of a Urea-Urethane (Meth)Acrylate Oligomer According to the Invention

50.00 g of the intermediate with secondary diamine prepared in Example 14 and BHT (0.100 g) were placed at 23° C. in a reactor equipped with a reflux column, a dropping funnel, a thermometer and an inclined paddle stirrer. The reactor was heated at 50° C. until the BHT was completely dissolved. 96.54 g of the HDI-pentaerythrityl triacrylate adduct intermediate prepared in Example 15 were introduced via the dropping funnel over 30 minutes. The reactor was heated to 80° C. and maintained at this temperature for 2 hours before being cooled. The isocyanate number I_{NCO} and amine number I_{Amine} of the oligomer obtained were measured:

I_{NCO}=0 mgKOH/g and I_{Amine}=2.7 mgKOH/g.

### Example 17: Preparation of a Urea-Urethane (meth)acrylate Oligomer according to the invention

While sparging with dry nitrogen at a flow rate of 20 mL/minute, DEM (28.21 g) was introduced at 23° C. into a reactor equipped with a reflux column, two dropping funnels, a thermometer and an inclined paddle stirrer. Jeffamine® ED-600, whose amine number I_{Amine} was measured at 179.0 mgKOH/g (50.16 g), was introduced via a dropping funnel over 30 minutes. The reactor was heated at 100° C. for 7 hours and then cooled to 65° C. The nitrogen sparge was then replaced with an air sparge at a flow rate of 20 mL/minute. HDDA (30.00 g) was then added, and the temperature maintained at 65° C. for 1 hour. The reactor was cooled to 50° C. HQME (0.100 g) was then added. 110.00 g of the HDI-pentaerythrityl triacrylate adduct intermediate prepared in Example 15 were added via the second dropping funnel over a period of 45 minutes. The temperature was brought to and maintained at 80° C. for 3 hours. The isocyanate number INCO and amine number I_{Amine} of the oligomer obtained were measured:

$${I}_{NCO} = 0 mgKOH / g and {I}_{Amine} = 2.4 mgKoh / g$$

### Example 18: Preparation and Evaluation of Polymerizable Compositions Based on Urea (Meth)Acrylate Oligomers According to the Invention

Compositions were prepared from the urea (meth)acrylate oligomers of Examples 1, 2 and 3 of the invention. The oligomers were preheated to 65° C., and then, with manual stirring, a photoinitiator was introduced and dissolved. The mixtures were then allowed to return to room temperature (25° C.). The compositions are shown in Table 5 below (the amounts are indicated in grams).

TABLE 5

| Compositions | A | B | C |
|---|---|---|---|
| Oligomer of Ex. 1 | 96 | — | — |
| Oligomer of Ex. 2 | — | 96 | — |
| Oligomer of Ex. 3 | — | — | 96 |
| SpeedCure ® 73 | 4 | 4 | 4 |
| Brookfield S34 viscosity, | 4553 | 3401 | — |
| 10 rpm at 25° C. (mPa · s) | | | |
| Noury viscosity at 50° C. (mPa · s) | — | — | 14 450 |

The application properties of the films obtained after photopolymerization, using compositions A, B and C, were evaluated and are summarized in Table 6 below:

TABLE 6

| Compositions | A | B | C |
|---|---|---|---|
| Reactivity (number of passes at 5 m/min) | 10 | 10 | 2 |
| Persoz hardness (s) | 245 | 255 | 345 |
| Pencil hardness | 6B | 6B | H |
| Flexibility (mm) | 16 | 13 | >32 |
| Resistance to acetone (s) | 142 | 278 | >300 |

The application properties of the films obtained from compositions A, B and C are varied: good film formation with a good performance compromise (for the film obtained from composition A), flexibility (for the film obtained from composition B), excellent hardness and chemical resistance (for the film obtained from composition C).

### Example 19: Preparation and Evaluation of Polymerizable Compositions Based on Urea (meth)acrylate Oligomers According to the Invention, and of a Comparative Composition

Compositions were prepared from the urea (meth)acrylate oligomers of Examples 4, 5 and 6 of the invention and a comparative oligomer. The oligomers were preheated to 65° C., and then, with manual stirring, a photoinitiator was introduced and dissolved. The mixtures were then allowed to return to room temperature (25° C.). The compositions are shown in Table 7 below (the amounts are indicated in grams).

TABLE 7

| Compositions | D | E | F | G | H |
|---|---|---|---|---|---|
| Oligomer of Ex. 4 | 40 | 75 | — | — | — |
| Oligomer of Ex. 5 | — | — | — | 60 | — |
| Oligomer of Ex. 6 | — | — | — | — | 60 |
| Aliphatic urethane diacrylate | — | — | 60 | — | — |
| oligomer CN981 | | | | | |
| 2,2-Dimethyl-1,3-dioxolan-4-yl) | 54 | — | — | — | — |
| methyl acrylate (IPGA) | | | | | |
| 1,6-Hexanediol diacrylate (HDDA) | — | 25 | 40 | — | — |
| SR238 | | | | | |
| Tricyciodecanemethanol acrylate | — | — | 4 | 38 | 38 |
| SR789 | | | | | |
| Ethyl(2,4,6-trimethylbenzoyl)phenyl | 6 | 2 | 2 | 2 | 2 |
| phosphinate (TPO-L) | | | | | |

### Additive Manufacturing:

3D objects were printed using the compositions described in the examples, from the printable object files shown in FIGS. 1-3, according to the protocol described previously. The oligomer-based compositions of the invention all proved to be usable in additive manufacturing.

The application properties of the objects obtained after photopolymerization, from compositions D, E, F, G and H, were also evaluated and are summarized in Table 8 below:

TABLE 8

| Compositions | | D | E | F | G | H |
|---|---|---|---|---|---|---|
| Tensile | Breaking | — | 40.7 | 35.8 | — | — |
| testing | stress (MPa) | | | | | |
| ISO 527-5A | Elongation | — | 8 | 12 | — | — |
| 2 mm/mn | (%) | | | | | |
| | Tensile | — | 2.3 | 1.6 | — | — |
| | modulus (GPa) | | | | | |
| Tensile | Breaking | 6.9 | — | — | 8.9 | 11.3 |
| testing | stress (MPa) | | | | | |
| ISO 527-5A | Elongation | 39 | — | — | 85 | 44 |
| 500 mm/mn | (%) | | | | | |
| | Tensile | 0.044 | — | — | 0.03 | 0.09 |
| | modulus (GPa) | | | | | |
| Tear strength | Resistance | — | 80 | 95 | 22.1 | 23.8 |
| D624-C | (N/mm) | | | | | |
| 500 mm/mn | | | | | | |
| Shore | | — | — | — | 66A | 82A |
| hardness | | | | | | |
| Dynamic | Ta (° C.) | — | 67 | 53 | 29 | 29 |
| Mechanical | | | | | | |
| Analysis | | | | | | |
| (DMA) | | | | | | |

The application results show that the oligomers of the invention lead to properties that are identical, or even superior, to those obtained with a conventional urethane acrylate (see Examples E and F), without the drawbacks associated with the preparation of a urethane acrylate, i.e. without the presence of metal residues (in particular tin) from the catalyst for the alcohol-isocyanate reaction.

The final properties of the crosslinked product can be readily modulated by adjusting the proportions of acrylate, amine and isocyanate, so as to obtain the desired final properties (see Examples G and H).

1. An oligomer comprising:
at least two urea bonds,
at least two (meth)acryloyloxy groups, and
optionally at least one urethane bond.

2. The oligomer as claimed in claim 1, wherein the at least two urea bonds are at least two hindered urea bonds and the at least two hindered urea bonds are linked together by a linker group, each hindered urea bond being connected to said linker group by a nitrogen atom not bearing any hydrogen atoms and the oligomer comprises at least one fragment corresponding to formula (I) below: 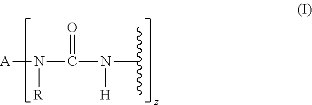
in which:
A is the residue of a polyamine,
R is other than H,
z is an integer from 2 to 6, and 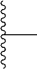
represents a point of attachment to a carbon atom.

3. The oligomer as claimed in claim 1, wherein the at least two urea bonds are directly linked to a group originating from an aza-Michael reaction between a primary amine and an α,β-unsaturated carbonyl compound.

4. The oligomer as claimed in claim 1, comprising at least two fragments corresponding to formula (Ia) below: 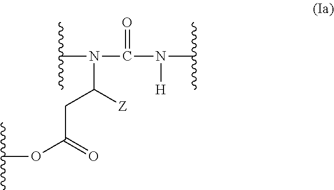
in which:
Z is H or a group comprising an ester function —COOY,
Y is an alkyl group, optionally substituted with one or more (meth)acrylate groups, and 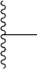
represent points of attachment to a carbon atom.

5. The oligomer as claimed in claim 1, comprising a fragment corresponding to one of the formulae (Id) or (Te) below: 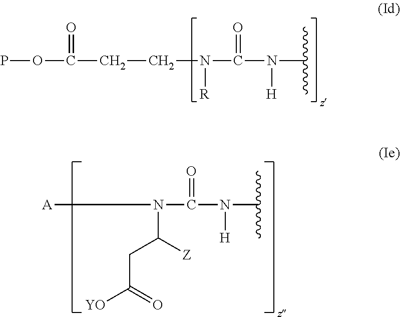
in which:
R is other than H, and preferably R is a hindered group,
Z is H or a group comprising an ester function —COOY;
Y is an alkyl group, optionally substituted with one or more (meth)acrylate groups,
P is the residue of a polyol, which is optionally alkoxylated or esterified,
A is the residue of a polyamine,
z′ is an integer from 2 to 6,
z″ is an integer from 2 to 6, and 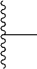
represents a point of attachment to a carbon atom.

6. The oligomer as claimed in claim 1, wherein the oligomer is the product of reaction between at least one poly(meth)acrylate, at least one hindered primary monoamine and at least one isocyanate compound, the oligomer being obtained via a process comprising the following successive steps:
(i) aza-Michael reaction between at least one poly(meth)acrylate and at least one hindered primary monoamine with a stoichiometric excess of (meth)acryloyloxy groups relative to the primary amine groups, and
(ii) reaction of the amino-(meth)acrylate mixture obtained in step (i) with at least one isocyanate compound with an NCO/NH₂ ratio of less than 1.05.

7. (canceled)

8. (canceled)

9. The oligomer as claimed in claim 1, wherein the oligomer is the product of reaction between at least one mono(meth)acrylate, at least one hindered primary polyamine and at least one isocyanate compound, the oligomer being obtained via a process comprising the following successive steps:
(i′) aza-Michael reaction between at least one mono(meth)acrylate and at least one hindered primary polyamine to form a poly(amino ester), with an NH₂/double bond ratio ranging from 0.7 to 1.3,
(ii′) optionally addition of an acrylate to eliminate the residual primary amine functions,
(iii′) reaction of the poly(amino ester) obtained in step (i′) or (ii′) with at least one isocyanate compound, and
in which the isocyanate compound comprises:
a polyisocyanate and a (meth)acrylate functionalized with an OH or NHR′ group, or
an adduct obtained by reaction between a polyisocyanate and a (meth)acrylate functionalized with an OH or NHR′ group, with a stoichiometric excess of NCO groups relative to the OH or NHR′ groups,
R′ being a group other than H.

10. The oligomer as claimed in claim 9, wherein the hindered primary polyamine corresponds to one of the formulae (IIIa), (IIIb), (IIIc), (IIId) and (IIIe) below: 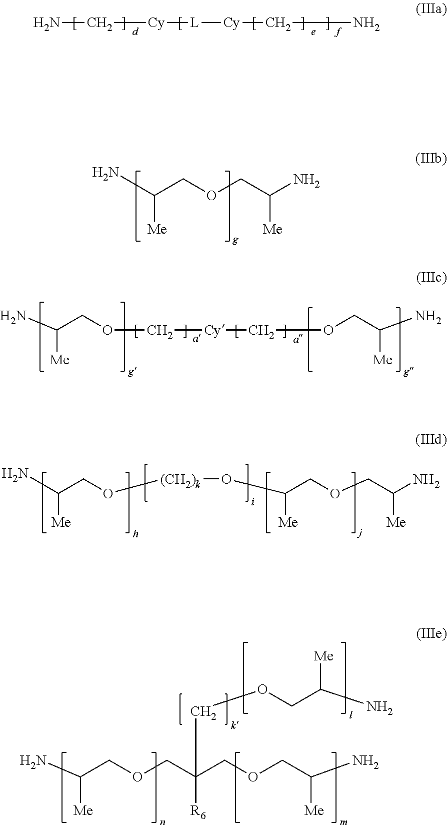
in which:
Cy is a C₄-C₈ ring, or Cy is —CR₄R₅—,
Cy′ is a C₄-C₈ ring,
R₄ is an alkyl group,
R₅ is H or an alkyl group,
R₆ is H or an alkyl or alkoxy group,
L is a single bond, an alkylene or an oxyalkylene,
a′, a″, d, e and f are, independently of each other, equal to 0 or 1,
g, g′, g″, h, i, j, l, m and n are, independently of each other, integers ranging from 1 to 50,
k is equal to 2 or 4,
k′ is equal to 0 or 1, and
in particular the hindered primary polyamine is chosen from: 5-amino-1,3,3-trimethylcyclohexanemethylamine (isophorone diamine), 4,4′-methylenebis(cyclohexylamine), 4,4′-methylenebis(2-methylcyclohexylamine), 1,2-, 1,3- or 1,4-diaminocyclohexane, 1,2-, 1,3- or 1,4-cyclohexanebis(methylamine), 1,8-diamino-p-menthane, o-, m- or p-xylylenediamine, a non-cyclic polyether diamine based on polypropylene glycol and optionally polyethylene glycol or polytetramethylene glycol preferably having a weight-average molecular weight M_{w} ranging from 200 to 10 000 g·mol⁻¹ a polyether triamine based on polypropylene glycol and optionally polyethylene glycol, preferably having a weight-average molecular weight M_{w} ranging from 300 to 10 000 g·mol⁻¹, a cycloaliphatic polyether diamine preferably having a weight-average molecular weight MW ranging from 500 to 5000 g·mol⁻¹, and mixtures thereof.

11. The oligomer as claimed in claim 1, wherein the oligomer is the product of reaction between at least one diester maleate or fumarate, at least one primary polyamine and at least one isocyanate compound, the oligomer being obtained via a process comprising the following successive steps:
(i″) aza-Michael reaction between at least one maleate or fumarate diester and at least one primary polyamine to form a poly(amino ester), with an NH₂/double bond ratio ranging from 0.7 to 1.3,
(ii″) reaction of the poly(amino ester) obtained in step (i″) with at least one isocyanate compound, and
in which the isocyanate compound comprises:
a polyisocyanate and a (meth)acrylate functionalized with an OH or NHR′ group, or
an adduct obtained by reaction between a polyisocyanate and a (meth)acrylate functionalized with an OH or NHR′ group, with a stoichiometric excess of NCO groups relative to the OH or NHR′ groups,
R′ being a group other than H.

12. The oligomer as claimed in claim 1, comprising at least one product corresponding to formula (IV) below: 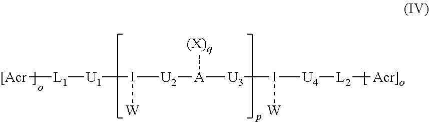
in which:
each Acr is, independently of each other, a (meth)acryloyloxy group,
L₁ and L₂ are, independently of each other, [●]ₒ—P—[O—C(═O)—CH₂—CH₂]ᵣ-♦,
P is the residue of a polyol, and preferably P is an optionally alkoxylated or esterified alkylene,
the symbol ● represents a point of attachment to an Acr group,
the symbol ♦ represents the point of attachment to the group U₁ or U₄,
U₁ and U₄ are, independently of each other, chosen from a urea bond or a urethane bond,
U₂ and U₃ are a urea bond,
I is the residue of a polyisocyanate,
W is absent or represents a branch on the oligomer,
A is the residue of a polyamine,
X is absent or represents a branch on the oligomer,
each o is, independently of each other, an integer ranging from 1 to 5,
p is an integer ranging from 0 to 50, on condition that when p is equal to 0, at least one of the groups U₁ or U₄ is a urea bond,
each q is, independently of each other, an integer from 0 to 4, and
r is equal to 0 or 1.

13. The oligomer as claimed in claim 12, wherein the (meth)acryloyloxy groups Acr are, independently of each other, represented by formula (V) below: 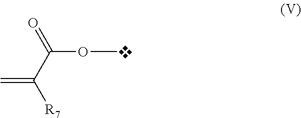
in which:
R₇ is H or a methyl group, and
the symbol [symbol] represents the point of attachment to the group L₁ or L₂.

14. The oligomer as claimed in claim 12, wherein each I is the residue of an aliphatic, cycloaliphatic or aromatic polyisocyanate.

15. The oligomer as claimed in claim 12, wherein U₁ and U₄ are, independently of each other, a urea bond represented by formula (VI) below: 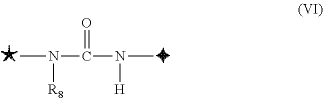
in which:
R₈ is a hindered group,
the symbol ★ represents the point of attachment to group L₁ or L₂,
the symbol [symbol] represents the point of attachment to group I, and
when p>0, U₂ and U₃ are, independently of each other, a urea bond represented by formula (VII) below: 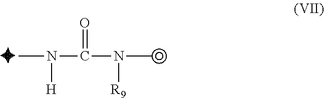
in which:
R₉ is a hindered group,
the symbol ⊚ represents the point of attachment to the group A, and
the symbol [symbol] represents the point of attachment to the group I.

16. (canceled)

17. The oligomer as claimed in claim 12, wherein U₁ and U₄ are, independently of each other, a urea bond represented by formula (IX) below: 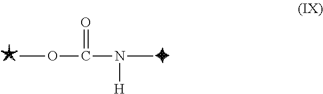
the symbol ★ represents the point of attachment to group L₁ or L₂,
the symbol [symbol] represents the point of attachment to group I,
p>0 and U₂ and U₃ are, independently of each other, a urea bond represented by formula (X) below: 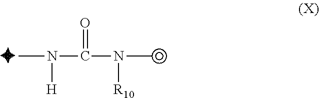
in which:
R₁₀ is other than H, and preferably R₁₀ is a hindered group,
the symbol ⊚ represents the point of attachment to group A,
the symbol [symbol] represents the point of attachment to group L.

18. (canceled)

19. The oligomer as claimed in claim 17 wherein:
r is equal to 0,
L₁ and L₂ are, independently of each other, [●]ₒ—P-♦,
P is the residue of a polyol, and preferably P is an optionally alkoxylated or esterified alkylene,
o is an integer ranging from 1 to 5,
the symbol ● represents a point of attachment to an Acr group,
the symbol ♦ represents the point of attachment to the group U₁ or U₄.

20. (canceled)

21. The oligomer as claimed in claim 17, wherein A is the residue of an unhindered polyamine A is chosen from one of the groups of formulae (XIVa), (XIVb), (XIVc), (XIVd), (XIVe) or (XIVf) below: 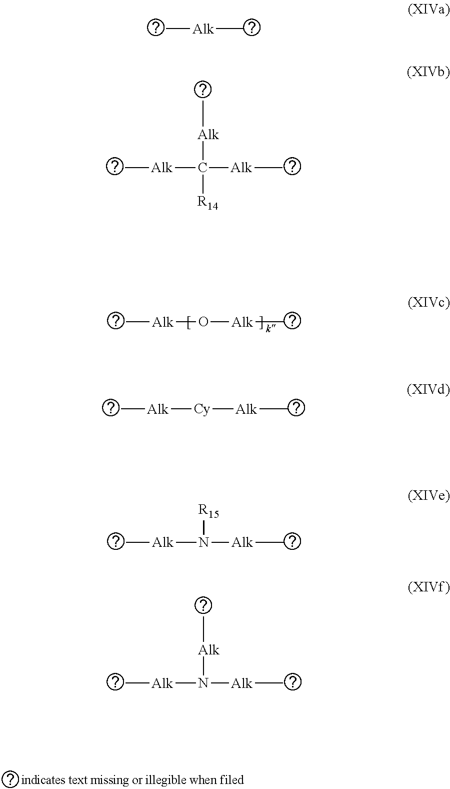
in which:
Alk is alkylene, optionally substituted with one or more groups independently chosen from alkyl and alkenyl,
Cy is a ring, optionally substituted with one or more groups independently chosen from alkyl and alkenyl,
R₁₄ and R₁₅ are, independently of each other, H or an alkyl group,
k″ is an integer from 1 to 50,
the symbol □ represents the point of attachment to U₂ or U₃.

22. The oligomer as claimed in claim 15, wherein:
r is equal to 1,
L₁ and L₂ are, independently of each other, [●]ₒ—P—O—C(═O)—CH₂—CH₂-♦,
P is the residue of a polyol, and preferably P is an optionally alkoxylated or esterified alkylene,
the symbol ● represents a point of attachment to an Acr group,
the symbol ♦ represents the point of attachment to the group U₁ or U₄.

23. (canceled)

24. (canceled)

25. A polymerizable composition comprising at least one oligomer as claimed in claim 1 and optionally at least one other ethylenically unsaturated compound.

26. (canceled)

27. The polymerizable composition as claimed in claim 25, wherein the polymerizable composition is an ink composition, a coating composition, a material filled with fibrous or particulate reinforcements which may be carbon nanotubes or graphite, an adhesive composition, a molding composition, an ink plate composition, an electrode binder composition, or a composition for additive manufacturing.

28. A process for manufacturing a crosslinked product, comprising crosslinking a polymerizable composition as claimed in claim 25, by exposing said composition to radiation.

29. (canceled)

30. (canceled)

31. A crosslinked product obtained by crosslinking a polymerizable composition as claimed in claim 25.

32. The crosslinked product as claimed in claim 31, wherein the crosslinked product is an ink, a coating, a material filled with fibrous or particulate reinforcements which may be carbon nanotubes or graphite, an adhesive, a molded material, an ink plate, an electrode binder, or an object obtained by additive manufacturing.

33. (canceled)

34. (canceled)

35. (canceled)
